(19) United States
(12) Patent Application Publication
(10) Pub. No.: US 2021/0394080 A1
(43) Pub. Date: Dec. 23, 2021

(54) EVAPORATORS, CONDENSERS AND SYSTEMS FOR SEPARATION

(71) Applicant: SATISH G. KANDLIKAR, Rochester, NY (US)

(72) Inventor: SATISH G. KANDLIKAR, Rochester, NY (US)

(73) Assignee: Rochester Institute of Technology, Rochester, NY (US)

(21) Appl. No.: 17/355,631

(22) Filed: Jun. 23, 2021

Related U.S. Application Data
(60) Provisional application No. 63/042,792, filed on Jun. 23, 2020.

(51) Int. Cl. B01D 1/22; B01D 5/00

(52) U.S. Cl. CPC B01D 1/221; B01D 5/006; B01D 5/0015

(57) ABSTRACT

The current disclosure provides a method to improve the performance of evaporators and condensers by maintaining the vapor velocities on the heat exchange surfaces within a desired range. This is accomplished by providing a constant or tapered narrow gap for vapor flow in the heat exchangers. The shear induced by the vapor over the heat exchanger improves the evaporator performance by disturbing the liquid film flowing over the heat transfer surface. In the condenser, the vapor shear helps to remove the condensate in the form of film and droplets, and also removes the non-condensable gases from the heat transfer surfaces as the vapor condenses out and increases the concentration of the non-condensable gases over the heat transfer surfaces. Parameters identified include minimum gap and the taper angle between the cover plate and heat transfer surface.

### CROSS REFERENCE

This application claims the benefit of the filing date of U.S. Provisional Patent Application No. 63/042,792, filed Jun. 23, 2020, which is hereby incorporated by reference in its entirety.

### FIELD

The present disclosure relates to methods, apparatus, and systems for the evaporation of liquid and condensation of vapor.

### BACKGROUND

The evaporators and condensers used currently in systems for separation such as in desalination plants employ large heat exchanger volume per unit heat transfer surface area. The heat transfer in a falling film evaporator relies on the film flow and the heat transfer coefficients are low because of the low interfacial shear existing between the vapor and liquid film. In condensers, the condensed liquid appears in the form of liquid droplets or film and these adversely affect the heat transfer coefficient. Further, there is a buildup of non-condensable gases that are left behind at the condensing surface and this buildup introduces a heat and mass transfer resistance that is detrimental to the condenser heat transfer coefficient. These problems are addressed in this disclosure. The methods described in this disclosure will lead to savings in equipment costs as well as operating costs. These methods are applicable in other systems employing evaporators and condensers.

### SUMMARY

In accordance with one aspect of the present disclosure, there is provided an evaporator, including:
a flow channel having two open ends, the flow channel having a heat transfer plate, optionally two sidewalls, and a cover plate enclosing the flow channel;
a feed liquid inlet at one end of the flow channel;
a feed liquid outlet at the other end of the flow channel;
optionally, a vapor flow inlet at one end of the flow channel; and
a vapor flow outlet at the other end of the flow channel, wherein a gap at the feed liquid outlet between the surface of the heat transfer plate and the surface of the cover plate is in the range of from 1 mm to 200 mm and wherein an angle between the surface of the heat transfer plate and the surface of the cover plate is in the range of from 0.5 to 20 degrees

In accordance with another aspect of the present disclosure, there is provided a condenser, including:

a flow channel having two open ends, the flow channel having a heat transfer plate, optionally two sidewalls, and a cover plate enclosing the flow channel;

a vapor inlet at one end of the flow channel; and

a condensed liquid outlet at the other end of the flow channel, wherein a gap at the condensed liquid outlet between the surface of the heat transfer plate and the surface of the cover plate is in the range of from 1 mm to 200 mm and wherein an angle between the surface of the heat transfer plate and the surface of the cover plate is in the range of from 0.5 to 20 degrees.

In accordance with another aspect of the present disclosure, there is provided a combined evaporator and condenser unit, including:

an evaporator flow channel having two open ends, optionally two sidewalls, and an evaporator cover plate enclosing the evaporator flow channel;
an evaporator flow channel feed liquid inlet at a first end of the unit;
an evaporator flow channel feed liquid outlet at a second end of the unit;
optionally, an evaporator flow channel vapor flow inlet at the second end of the unit;
an evaporator vapor flow outlet at the first end of the flow channel;

a condenser flow channel having two open ends, optionally two sidewalls, and a condenser cover plate enclosing the condenser flow channel;
a condenser flow channel vapor inlet at the first end of the unit;
a condenser liquid outlet at the second end of the unit; and
a common heat transfer plate disposed between the evaporator cover plate and the condenser cover plate, wherein an evaporator gap at the second end of the unit between the common heat transfer plate and the evaporator cover plate and a condenser gap at the second end of the unit between the common heat transfer plate and the cover plate are each independently in the range of from 1 mm to 200 mm and wherein an angle between the surface of the common heat transfer plate and the surface of the evaporator cover plate and an angle between the surface of the common heat transfer plate and the surface of the evaporator cover plate are each independently in the range of from 0.5 to 20 degrees.

These and other aspects of the present disclosure will become apparent upon a review of the following detailed description and the claims appended thereto.

### BRIEF DESCRIPTION OF THE DRAWINGS

FIG. 1 shows an evaporator plate over which feed liquid is introduced in accordance with the present disclosure;

FIG. 2A shows the front view AA of the evaporation plate shown in FIG. 1 and FIG. 2B shows an embodiment of a system with spray distribution on the evaporation plate, and FIG. 2C shows the vapor flowing over the heat transfer surface;

FIG. 3A shows the evaporator with a constant gap for vapor flow in which evaporation takes place and FIG. 3B shows a tapered gap configuration which increases in the vapor flow direction to maintain the velocity of vapor within certain limits;

FIG. 4A shows a condenser with an inclined condensing plate, FIG. 4B shows a condensation cover plate placed parallel over the condenser plate, and FIG. 4C shows the condenser cover plate not parallel to condenser plate forming a tapered gap through which vapor flows;

FIG. 5 shows an embodiment in which two condenser plates are incorporated in one condenser;

FIG. 6 shows an embodiment of an evaporator;

FIG. 7 shows an embodiment of an evaporator and a condenser;

FIG. 8 shows an embodiment of an evaporator and a condenser;

FIG. 9 shows an embodiment of the system in which some of the present components are combined; and

FIG. 10 shows an embodiment of a multistage desalination system.

### DETAILED DESCRIPTION

The current technology is applicable to processes where evaporation of liquid and condensation of vapor are used. Among the potential applications, it is applicable to processes such as desalination for separating liquid from a solution and separation processes in chemical, petrochemical and other applications. It is also applicable to processes involving evaporation and condensation. Elements of the technology can be applied in an individual component design and in an overall system design incorporating multiple components. The technology presents techniques to improve evaporator efficiency. It also presents techniques to improve condenser efficiency. Together, it presents a technique to improve the overall system efficiency. The problems presented by the prior systems are addressed by providing a narrow gap through which the vapor flows in both evaporators and condensers. The narrow gap results in increased vapor velocity which disturbs the falling film in the evaporator and removes condensed liquid drops or film more efficiently due to the high shear stress induced by the vapor flow. Further, the vapor flow removes the non-condensable gases from the condenser heat transfer surfaces and prevents buildup of non-condensable gases. To maintain the vapor velocity in a desired range to provide the necessary shear stress, the flow channel in the heat exchangers are tapered such that the cross-section increases in the direction of increased vapor flow. The use of narrow gap reduces the heat exchanger volume, which is beneficial in reducing the cost of equipment as well as maintaining vacuum and removing non-condensable gases.

Evaporation occurs in a flow channel having a tapered gap or in a flow channel having uniform gap, where vapor is generated from a pure liquid or mixture, for example water or saline water, flowing over a solid surface. The evaporation process occurs over a film or stream of feed water. The resulting vapor velocity in the flow direction in the channel enhances the evaporation heat transfer coefficient. The vapor velocity is preferably kept in a range of desired high values to impart vapor shear on the evaporating water surface. The vapor shear induced by the flowing vapor generates an enhancement effect. The evaporating water surface can have enhancement features, including but not limited to continuous fins, non-continuous fins, offset fins, open microchannels, coatings and the like. A vapor flow channel or channels are confined by placing a cover on the heat transfer surface and enclosing the sides with sidewalls, with inlet for recirculated vapor if desired and exit for evaporated vapor. There can be a single passage in the channel with cross-communication over other areas, or multiple channels, which may be essentially parallel to each other and separated by walls extending from the substrate to the cover, fully or partially, enclosing the channel. The vapor stream and the feed water stream are preferably placed in countercurrent arrangement, although other arrangements such as concurrent flow, crossflow or any combinations are possible. The height of the channel at any section is defined as the height of the gap that is normal to the heat transfer surface and is the distance between the heat transfer surface and the cover. The gap may be uniform or variable. A suitable gap distance occurring at the liquid outlet section of either the condenser or evaporator in accordance with the present disclosure is a distance of from 1 mm to 200 mm, preferably a distance of from 5 mm to 50 mm. In the case of variable gap, the gap may increase in the vapor flow direction over the heat transfer surface in the evaporator or may decrease in the case of the condenser. The taper may be continuous, variable or stepwise changing. The selection of gap depends on the desired vapor velocity; an enhancement effect of at least by 10 percent is desired as compared to stagnant vapor flow exerting no shear stress on the film. In some cases, the vapor shear may be used to make the film thick by flowing against the liquid flow direction. This helps in preventing dry-out and precipitation of salt or solute from the solution. Channel heights beyond these ranges are also included, although the preferred ranges are indicated. The height of the flow channel normal to flow direction and the heat transfer surface is much smaller than the length of the flow channel along the flow direction; the ratio of length to height at inlet or outlet of the vapor being in the range of from 1.1 to 50,000; preferably, 1 to 100; 10 to 10,000; and more preferably, 50 to 5000. The desired vapor velocity can be achieved by selecting appropriate gap distance and taper angle for a given rate of vapor generation, which depends on the heat transfer from the heat transfer surface. A suitable taper angle in accordance with the present disclosure includes an angle in the range of from 0 to 20 degrees, preferably in the range of from 0.5 to 20 degrees, more preferably in the range of from 1 to 10 degrees, most preferably in the range of from 3 to 10 degrees. Taper angle is relevant in affecting the vapor velocity in the channel. It may be taken as the average estimated from the flow area change along the channel length in the flow direction. Sudden expansion or contraction near the inlet or outlet sections may be excluded in determining the taper angle. In the case of step functions in the gap size, average taper may be calculated based on inlet and outlet gap. These dimensions and ratios and the description related to evaporator in this disclosure are also applicable to a condenser with tapered or uniform gap flow channels. Heat of vaporization in the evaporator may be supplied by one or more of the following modes—by the feed water itself, by a heating medium providing heat to the feed liquid as it flows over the evaporator surface, or both. Direct radiant heating is also possible including solar systems. In another embodiment, open microchannel and minichannel evaporators can be used. As the new vapor is generated, increased flow area along the flow length of the vapor helps in keeping the vapor velocity within the desired limits. By using the small heights, the vapor shear is kept high for improving the heat transfer process. The equipment system size becomes small for the same heat transfer rate. As the vapor generation increases, the vapor shear also increases due to increased velocity when the flow area is kept constant. Very high vapor shear is not desirable as it may cause disruption in the flow of feed water over the heat transfer surface. It may also cause the water film to be sheared away exposing bare heat transfer surface. The gap above the evaporator surface can be varied along the flow length to accomplish the area changes. The features described for evaporation are applicable to condensation process as well after accounting for the fact that during condensation, vapor is removed rather than generated as in the case of evaporation. Removing liquid from a condenser surface may be desirable as it exposes the surface directly to condensing vapor. In condenser, if the gap is too small, flooding of the gap with condensate may occur at least in part of the condenser. If the gap is too large, the vapor shear may be insufficient to induce enhancement in a condensation heat transfer process. Latent heat released during condensation is removed by the heat transfer surface over which condensation occurs. Evaporator and condenser may be designed for periodic cleaning to remove fouling deposits, including salt precipitated from the solution.

Condensation of vapor occurs over a surface that is kept below its saturation temperature. The condensate flows over the heat transfer surface and eventually is removed and collected as the product water in a desalination plant. The vapor flow induces an interfacial shear stress between the condensed liquid and flowing vapor that assists in at least one of the effects due to (i) removal of the condensate film, (ii) thinning of the condensate film to improve condensation heat transfer coefficients, and (iii) improvement in the condensation heat and mass transfer coefficients by removing or reducing the buildup of non-condensable gases over the condensing surface. The liquid removal is accomplished by drainage induced by gravity in one embodiment. In another embodiment, open microchannel and minichannel condensers can be used and the vapor shear is used to remove the condensate. The vapor shear may be able to overcome gravity in certain embodiments. The terms microchannel and minichannel refer to the dimensions of the channel height normal to the heat transfer surface. The gap or height may be in the range of conventional channels. This height may be in the range of from 1 mm to 200 mm, more preferably 5 mm to 50 mm, more preferably 5 mm to 20 mm or more depending on the vapor flow rate. Further, the cross-sectional area can be reduced along the vapor flow direction. Tapered gap, with gap decreasing in the vapor flow direction, can be provided to accomplish the cross-sectional area changes in the condenser. In one embodiment, the gap may be kept constant at least in some region of the condenser or an evaporator. In another embodiment, the gap may increase or decrease in the vapor flow direction for condenser and evaporator although it may be within desired range for enhanced performance.

The gap size determination also relates to the flooding conditions in both evaporators and condensers described in this disclosure. If the gap is too small and the liquid flow rate is high, then the space may become filled with liquid. The minimum gap size should account for this condition. In the evaporator, vapor generation may continue to occur by boiling even under flooded conditions but if film evaporation is desired, then the gap should be increased. In condensers, if the minimum gap size is too small and the flow channel becomes flooded, then the vapor has no access over the condenser plate and the condensation rate will suffer. Thus, the minimum gap size should take into account this flooding condition and suitably larger gap sizes would be used to overcome the flooding problem.

Another feature is that vacuum is provided so that the evaporation temperature is lowered in the evaporator, and the vacuum coupled with flow condensation improves condenser performance. When other gas is present, such as in the case of humidification-dehumidification systems, the vacuum reduces the effect of the non-condensable gas as its partial pressure is reduced while the partial pressure of water vapor at the condensing surface remains the same dependent on the condensation surface temperature. The net effect is that the driving vapor pressure potential is improved when the pressure of the system is reduced. Presence of another gas is significantly reduced by having a vapor shear removing the gas from condensing surface. These features enable the use of lower temperature heat source in the evaporator and higher temperatures in the condenser. The gap is changed such that the vapor velocity at any cross-section is maintained within the desired limits that is effective in achieving at least one or more of the following in the condenser—heat transfer coefficient enhancement, condensate film thinning, condensate film removal, and carrying away the non-condensable gases. The vapor velocity at any cross-section in the confined passage is defined as the volume flow rate across the cross-section divided by the cross-sectional flow area. In the case of an evaporator, the flow velocity should not completely remove the liquid film which adversely affects the film flow and causes dry-out patches. Very high velocity may disrupt the flow of feed water and cause flooding or reversed flow, which will disrupt the operation. The gap is kept narrow to create a high vapor velocity since a higher vapor velocity improves the heat and mass transfer coefficients. However, making the gap too small causes large pressure drops introduced by the flow resistance to vapor flow in narrow passages.

Either or both the condensation and evaporation processes are accomplished under a vacuum. By lowering the pressure in the evaporator, the saturation temperature is reduced and the evaporation can occur at lower temperatures, enabling working with lower temperature energy sources, including but not limited to, solar energy, geothermal energy, waste heat, heat from processes such as steel mills, automobile exhaust, power plant systems, chemical and process plants, diurnal temperature cycles, and ocean thermal energy. The vacuum however causes the non-condensable gases to outgas from the feed liquid. Removal of the non-condensable gases at the condensing surface reduces the thermal resistance introduced by the film of the non-condensable gasses formed over the condensate. As vapor condenses, it leaves behind the non-condensable gases which cause a reduction in the condensation rate due to the mass transfer resistance introduced by the film of higher concentration of non-condensable gases over the condensing surface. This film is rich in non-condensable gases. This becomes a more important factor in humidification-dehumidification systems as the carrier gas, defined as the gas which carries the water vapor in such systems, is essentially a non-condensable gas. Use of the vapor shear introduced in this technology improves the performance of components in humidification-dehumidification based systems also.

The vacuum may be introduced in a continuous manner or in a batch type operation in which the system vacuum is applied at certain intervals to limit the pressure rise below the desired limits. The desired limits are determined from the available temperatures of the heating and cooling sources. The system efficiency also plays an important role as a deep vacuum may be more expensive although the system efficiency may be high. The trade-off depends on the economic considerations such as fixed costs, operating costs, size, etc.

An after-condenser operating at a lower temperature may be introduced after the condenser to further remove the vapor before discharging the non-condensable gas rich mixture through the vacuum pump, or recirculated in the evaporator until a desired maximum concentration of the non-condensable gases is reached. It is preferable to keep the overall volume of the system low to reduce the volume of the space being evacuated. Use of the flow evaporation and flow condensation processes introduced in the technology is able to reduce the volume of the vapor space. The evaporator and condenser may be incorporated individually or together in an enclosure such that vapors generated can traverse directly to the condenser. A separating baffle with vapor passages may be introduced to reduce liquid carryover from evaporator to condenser or vice versa. In cases where the benefits of the higher velocities are desired only in either the evaporator or in the condenser, implementing an appropriate tapered gap for vapor flow in the respective unit, increasing gap in evaporator and decreasing gap in condenser, may be implemented. It is desirable to keep the flow velocity of the exiting vapor from the evaporator high during its passage to the condenser and keep the pressure losses low in the passage as they will require a lower condensing temperature to condense the vapor and reduce the thermal efficiency of the system. A system may utilize only the flow evaporator or flow condenser as described herein. A flow evaporator means an evaporator in which vapor flow along the heater surface in introduced by using channels described herein. A flow condenser is similarly defined.

Enhancement features such as fins, microchannels, minichannels, grooves, wicking structures and coatings, porous coatings, microscale, nanoscale or macroscale features, or any other known enhancement devices and techniques, individually or in combination with other features, may be implemented on the surfaces of the evaporator and condenser to improve either the heat transfer coefficient or mass transfer coefficient or both. These features may be deigned to facilitate liquid distribution over the surface and avoid salt precipitation. Nanoscale pores and membranes may be implemented on these surfaces to improve the condensation or evaporation processes by improving one or both mass transfer and heat transfer coefficients.

Coatings, including but not limited to hydrophilic structures, hydrophilic coverings, microstructures and other features, may be applied on the evaporator surface to improve wetting and film flow characteristics of the solution over the heated surfaces.

Microchannels, grooves, hierarchically structured micro and nanostructures, flow collecting channels, heat transfer enhancement features, mass transfer enhancement features, and other features to improve the condensation or evaporation performance may be implemented on the respective condensing or evaporation surfaces.

Either or both the evaporation and condensation processes may be carried out in an atmosphere of a mixture of an inert gas such as helium and air or nitrogen. Other gases may be employed. This may be done in conjunction with any feature described in this invention or combinations of these features, for example, tapered channels with microstructures on the heat transfer surfaces, etc. The inert gas may be hydrogen, helium, neon, argon or any gas that has low solubility, similar to the gases listed here, in water or solution being heated or condensed. It is preferable to use a gas with higher mass diffusivity. It is preferable to use a gas with higher thermal conductivity. Helium is a preferred gas as it has both higher mass diffusivity and higher thermal conductivity than air. Cost is another factor to be considered. The acceptable helium concentration in the air in the system can vary over a wide range. Using a mixture of air and helium is less expensive than using only helium alone as the system can function even with a limited leakage of air in or helium out of the system. The normal value of helium concentration is 0.000053 mole fraction in the air, which is the non-condensable gas in a humidification-dehumidification based desalination system. The system may contain helium gas in the range of from 0.001 to 99.99 mole percent of the non-condensable gas in the system or at any location; a preferred range is 0.1 mole percent to 99 mole percent; another preferred range is 1 mole percent to 99 mole percent; another preferred limit for lower range is 5 mole percent; another preferred lower limit for the range is 10 mole percent; another preferred lower limit for the range is 15 mole percent; another preferred lower limit for the range is 20 mole percent; another preferred lower limit for the range is 40 mole percent; another preferred lower limit for the range is 50 mole percent; another preferred higher limit for the range is 95 mole percent; another preferred higher limit for the range is 85 mole percent; another preferred higher limit for the range is 80 mole percent; another preferred higher limit for the range is 70 mole percent; another preferred higher limit for the range is 60 mole percent; and another preferred higher limit for the range is 55 mole percent.

The evaporator and condenser may be cascaded such that the temperature ranges of heating or cooling fluid used in these heat exchangers is split individually to provide more than one stage of condensation or evaporation processes. The condensate and feed water may be used as heating or cooling fluids in some heat exchangers in the system

Feed liquid is distributed over the evaporator plate to flow as a film. The plate may be inclined and the inclination angle can vary from 90 degrees to 0 degrees to horizontal surface with the water flowing over by gravity down the plate or being forced by the shear of the vapor flow. The evaporator plate may be vertical, upward facing, downward facing or horizontal. The evaporator plate may be horizontal and the vapor driving the flow of liquid as film. A preferred arrangement is an upward facing evaporator surface with an angle to horizontal of from 85 to 1 degrees. This arrangement is distinctly different from the slats or louvers that are placed in a spray-filled tower employing evaporation process. These louvers or slats are of short length that do not cover the entire or substantial length of over 50 percent of the evaporator. Further, these louvers or slats are adiabatic surfaces and do not contain a heating source. The taper flow arrangement in the evaporator and condenser is distinctly different from the flow diverters or other configurations used as they are specifically designed to introduce a vapor shear on the liquid at the heat transfer surface to cause at least one of the following—improve heat transfer coefficient, improve mass transfer coefficient, remove non-condensable gases, improve liquid film flow, improve liquid film distribution, improve liquid removal from the heat transfer surface, and improve removal from the system.

Feed liquid can be of any liquid mixture, including sea water in the desalination application, or water that has other substances which do not evaporate at the temperatures used in the device being used, or insoluble substances that do not evaporate or evaporate very little at the temperatures encountered. In one embodiment, dirty or brackish water can be used as the feed water. Feed liquid can be a solution or a mixture of a liquid and other substances. The evaporator may contain features to remove the solid substances including solute coming out as crystals or precipitating out from the solution. Precautions may be taken to reduce crystallization by controlling the feed rate and evaporation rate, and by controlling the liquid distribution over the evaporator surface. Evaporator surface and heat transfer surface are generally the same in a preferred embodiment.

The evaporator plate can have a distributor for the feed water to spread uniformly over its surface. The distributor may allow the feed water to flow through openings or slots. In another embodiment, the feed water can be sprayed on the evaporator plate, or it can be wicked, dripped, infused, channeled, or spread by any active or passive application. Any type of feed water distribution feature can be incorporated to provide flow of the feed water as a liquid film or liquid stream on the evaporator plate. Capillary forces may be used to provide liquid distribution.

The evaporator plate, also referred to as the evaporation plate or an inclined plate, can have grooves running parallel or across the flow direction, or the grooves may be at any angle to the flow direction. The surface can have a film flow obstructer in the form of fins, strips, grooves, diverters, etc. The flow of the feed liquid over the inclined plate may be obstructed by the surface features of the obstructions to improve the evaporation rate from the liquid. The inclined surface may be coated or covered with porous structures, including grooves, microgrooves, membranes, porous coatings, roughness features, microstructures, nanostructures, wicking material, fabric, metal or non-metal mesh, and any other feature (i) to enhance the evaporation rate from the feed liquid stream flowing over the inclined plate and (ii) to reduce crystallization of the solute and its being precipitated out from the solution. Any feature to improve the evaporation rate from the flowing liquid feed may be incorporated to improve the evaporation rate of the feed liquid.

The feed liquid can be introduced on to the inclined plate at one or more intermediate locations between the entrance and exit locations of the evaporator. The feed liquid temperature can be different at different locations. The feed liquid flow rate can be different at different locations.

The evaporator plate can be composed of any surface that is heated using any heating source including solar heat, waste heat, electric heat, geothermal heat, heat from other processes, etc. The heating can be performed by circulating the heating fluid in the heat exchanger in countercurrent, cross-current, concurrent modes or any combination compared to the vapor flow direction. The passages for the heating fluid can be incorporated underneath the evaporator plate. These passages can be embedded within the evaporator plate or tubes can be attached by mechanical fasteners or welding, brazing, soldering, bonding or other techniques on the front or back of the evaporator plate. The heating fluid flow passages can be formed by creating passages under the surface of the evaporator plate. The evaporator plate can be a continuous plate or a metal or non-metal surface which facilitates the flow of the feed liquid. In countercurrent mode, the heating fluid enters near the exit of the feed water and the heating fluid leaves near the entrance of the feed water. Any combinations of countercurrent, concurrent or transverse or cross flow passages can be incorporated. In an embodiment, if the evaporation is accomplished with heating of the feed stream prior to its distribution, the evaporator surface may be made of low conductivity materials. The evaporator plate material may be chosen to address corrosion and other issues such as ability to remove crystals formed, durability, etc.

The countercurrent flow of heating fluid to the flow direction of feed liquid is preferable as the evaporated vapor from the lower temperature section will not condense on the upstream liquid surface since the upstream liquid is hotter. The evaporated vapor may flow in the same or in the opposite direction to the feed liquid flow direction. A preferred flow direction may be opposite to the feed liquid flow direction.

Evaporation from the feed liquid flowing over the evaporator plate can be accomplished by using the sensible heat of the feed liquid. In another embodiment, the evaporation is accomplished by gaining heat from another heat source as the feed liquid flows over the plate. The heating source can include heated liquid, heated gas, heated air, heated solid surface or any other source which transfers heat by convection, conduction, radiation or any combination of heating modalities. In solar based systems, the tapered gap may be provided by the cover glass and the flat plate collector over which the feed water is distributed. The feed water in this case will gain heat by solar radiation.

Part of the feed liquid evaporates as it travels down the inclined surface. In a desalination application, the feed liquid is saline water while the evaporated vapor is pure water vapor. Some of the dissolved gases in the feed liquid can also be released as the feed liquid flows down the evaporator plate. The evaporated vapor and dissolved gases released can constitute the stream of vapor and gas mixture that leaves the flowing feed liquid. In addition, air, helium, any other gas or mixtures of gases may be present or introduced over the heat exchanger surfaces.

A purpose of the taper in the flow channel is to provide a certain range for vapor velocity. A uniform cross-sectional area channel that provides the desired vapor velocity range is also included in this technology. Thus, the flow channels can have any cross-section so long as the velocity of the vapor is sufficient to induce the desired heat transfer enhancement, greater than at least 10 percent over an arrangement where the vapor flow is not confined in a channel. The velocity can also be varied by removing vapor from the evaporator and adding vapor in the condenser at one or multiple locations along the vapor flow length. Feed water can also be added at one or multiple locations in the evaporator. Condensate can also be removed from one or multiple locations in the condenser. In one embodiment, the gap may be changed, continuously or in a stepwise fashion, depending on the operating conditions and other system considerations. In another embodiment, the taper may be changed depending on the operating conditions.

The system can be operated in the presence of a gas that has low solubility in the water or solution being used. The gas may be pure gas such as air, helium, hydrogen, etc. The gas may be a mixture of gases, with helium being one of the constituents. The mole fraction of helium in the mixture may range from 0.01 to 99.9 mole fraction of the mixture of gases. The concentration of helium may be in the ranges described elsewhere in this disclosure. The other constituent in the mixture may be air, nitrogen or any other pure gas or mixture of gases. Use of a gas mixture, such as helium and air is preferred. Helium has a high thermal conductivity and high mass diffusivity and enhances the condensation heat transfer. Using a mixture of helium and another gas such as air is highly desirable for at least the following reasons.
a. The quantity of helium used in the system would be lower than using pure helium. This will reduce the cost of the system.
b. The system is more tolerant to leakage of helium gas as the performance is still high. It may be noted that the diffusivity of the mixture varies as inverse mole-fraction averaged diffusivities of individual components. This is highly advantageous.
c. The present system is unique as to operate on the mixture of helium and another gas, such as air. The air may be replaced with other gases such as nitrogen or mixture to derive similar benefit.

In an embodiment, another cover surface is placed over the evaporator plate to provide a passage for the flow of vapor and gases released from the feed liquid. Some additional gases or vapors can also circulate in this passage. The passage may be a single passage or a plurality of passages that are formed by flow dividers placed on the evaporator plates. The flow passages can be supplied with feed water flow individually in each passage at the entrance of the feed liquid over the inclined plate. In another embodiment, the flow passages allow some crossflow of the feed liquid by having the dividers provide only partial openings between adjacent passages of the feed liquid. The gap between the evaporator surface and the cover surface is referred to as passage height or gap. The passage height determines the flow cross-sectional area available for the vapor flow. The flow velocity of the vapor over the evaporator plate is determined by the passage height, also called gap here, and passage width. The passage width can be the entire width of the inclined plate or it could be the width of the individual passage width for the flow of vapor on the plate. Individual passage sections with widths equal to or less than the width of the entire plate may be incorporated.

The velocity of the vapor as it flows over the evaporator plate which is covered partly or completely by the feed liquid is determined by the cross-sectional flow area available for the gases. The gap is between 1 mm to 200 mm. Larger gaps may be provided for larger systems where the length of the inclined plate is more than 1000 mm. The gap can be uniform or it can vary along the feed liquid flow direction. The gap is varied to maintain a certain velocity of vapor in the confined space to derive the benefits of vapor shear on the heat transfer and film flow performance.

The vapor flow passage may extend beyond the evaporator plate region that is covered by the feed liquid at the entrance and exit of the feed water. The flow passage walls may or may not have the heating source. Thus, there may be adiabatic sections of the flow passage walls beyond the feed liquid region at the entrance and at the exit from the evaporator. This adiabatic section can be used to channel the flow of vapor and liquid in certain directions. In one embodiment, the vapors are diverted towards the condenser section.

The gap determines the flow velocity of the vapor or the vapor-gas stream. As the gap becomes smaller, for the same flow rate, the vapor velocity will increase. The increased vapor velocity over a flowing feed liquid stream or film will result in a higher rate of evaporation. This is associated with increased evaporation rate due to at least one of the factors—higher relative velocity between the gas and the feed liquid streams across the evaporating liquid-vapor interface, turbulence or ripples caused by the relative velocity between the two streams, thinning of the liquid film, and improved heat transfer rate.

In one embodiment, the gap increases in the vapor flow direction in the evaporator. This accommodates the higher vapor flow rate resulting from additional evaporation occurring over the feed liquid surface while maintaining the vapor velocity within certain desired limits. These limits are formed by a need to maintain the liquid film over the evaporator surface and avoiding dry patches that may occur with higher velocities.

One aspect of the current disclosure is the improvement in the evaporation rate caused by the vapor stream flowing over the evaporating liquid-vapor interface. It may be noted that the vapor may contain some gas. Making the gap narrow causes the vapor velocity to increase. This causes a shear action on the liquid-vapor interface. The interface is also disturbed and waves or ripples may be created. These waves or ripples enhance the heat and mass transfer coefficients. The increased vapor velocity and the interaction of liquid and vapor with microstructures such as fins or flow obstructers, or membranes or other enhancement features also contribute to the improvement in evaporation rate.

At the end of the evaporator section, the remaining feed liquid is discharged through an opening. The opening may form a liquid seal with the liquid, or the liquid may empty in another container with interconnections for both phases. Additional vapor connections may be made at different locations for proper pressure balance in the system.

The vapor from the evaporator section flows toward the condenser section. The condenser can be made of any type, including spray type in which cold product liquid is sprayed providing condensing surface, or an inclined plate which is cooled by a cooling fluid stream. In one embodiment with the inclined plate, condensation occurs over the cooled plate in a uniform or tapered gap channel or channels and condensate flows down by gravity as a film or a stream. The condenser plate surface can incorporate features to enhance the condensation rate including grooves, microstructures, hydrophilic surfaces, biphilic surfaces, fins, microstructures and nanostructures, or any combinations of these and other condensation enhancement features. The inclined plate can be cooled by a cooling fluid in a counterflow or concurrent flow manner as compared to the vapor flow direction. It may include different cooling sections cooled by different temperature coolant streams. The use of specific coolant stream and flow loop may be determined by any energy efficiency strategy, including breaking the temperature rise into multiple sections of the condenser lengths on the inclined plate. Similar concepts can be employed on the evaporator side with appropriate adjustments to account for evaporation instead of condensation.

Another surface is placed over the condensation plate to form a gap through which the vapor flows in the condenser. The vapor condenses as it flows through the gap. The width of the gap determines the vapor velocity similar to the evaporator section. However, the vapor flow rate decreases as the condensation progresses. The gap may be reduced to keep the vapor velocities high for improving the condensation rates. The increased vapor velocity introduces a shear force on the vapor-liquid interface. This causes the interface to become thin, wavy or unstable and splash. The overall result is the improved condensation coefficients leading to higher condensation rates as the condensation heat transfer resistance is reduced. The two plates can have different surface features to achieve different functions, including increasing the condensation rates, improve drainage of the condensate film or both.

The two surfaces forming the vapor flow passages through the gap in the condenser may both be cooled, or only one of them may be cooled. Condensation may occur on one or both the surfaces. Condensation may occur over an upwards facing surface or a downward facing surface since maintaining a liquid film is not necessary during condensation. At is desirable to remove the film as quickly as possible, dropwise condensation may be encouraged. Vapor shear also helps in removing the condensate droplets from the surface.

The gap between the two surfaces forming the vapor flow passages determines the vapor flow velocity. The gap may be measured between the prime surface of the plates or between the top surfaces of the enhancement features. A prime surface of a heating or cooling surface is the surface over which fins or protrusions may be placed. The gap may be kept uniform or increase or decrease in the vapor flow direction. The gap may be constant across the width of the inclined plate or may be varying. The vapor mass flow rate will be decreasing in the vapor flow direction as condensation occurs in the condenser. The gap may be reduced in the vapor flow direction to keep the velocity constant, or increase the velocity, or decrease the velocity depending on the net effect desired on the local film thickness or the heat transfer coefficient. The gap at any location may be between 1 mm to 200 mm, more preferably 5 mm to 50 mm, more preferably 5 mm to 20 mm. Larger gaps may be incorporated for larger plate lengths in the vapor flow direction. The condensate may be drained from the lower section of the inclined plate. It may form a water seal into the condensate water collection tank or may be emptied into another container. A secondary condenser which provides cooler surface than the condensing plates in the condenser. This causes the additional vapor to condense and a vapor which is rich in non-condensable gases is left behind. The non-condensable gas and vapor mixture can be removed by employing a vacuum. The vacuum pump may be operated continuously or intermittently.

The feed liquid rate and the evaporated vapor fraction, ratio of evaporation rate to liquid feed rate, may be determined by considering the system efficiency and fouling considerations in addition to other considerations. Evaporation causes an increase in the concentration of other substances present in the liquid. A higher concentration of these substances may lead to increased fouling or lowering the rate of evaporation. The feed water circulation rate may be adjusted to avoid fouling or excessive fouling. Additional scraping or fouling removal mechanism may be implemented to reduce or remove the fouling materials over the heat transfer surfaces. Treatment of the feed liquid to reduce or avoid biological fouling may be introduced. The overall system may include other features required for proper or efficient operation of the system such as multi-staging in which multiple stages of evaporation and condensation processes are incorporated with different heating and cooling fluid streams to improve the overall system efficiency.

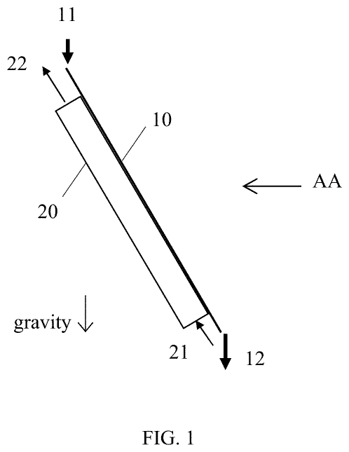

FIG. 1 details:
10—Evaporation plate
11—Feel liquid in
12—Feed liquid out
20—Evaporator heat exchanger
21—Heating fluid in
22—Heating fluid out

FIG. 1 shows an evaporator plate 10 over which feed liquid is introduced through inlet 11 designed to spread the feed liquid on the plate. Uniform distribution is desired to avoid dryout or liquid flowing in streams. Crystallization or precipitation of solute from the solution is also not desired. The plate is heated in a heat exchanger 20 with heating fluid which enters at inlet 21 and leaves at outlet 22. Any other type of liquid distribution system may be used, including spray, jets, distributor heads, etc.

Liquid feed contains soluble substances. Evaporation-condensation process is used to separate the liquid from the solutions. The process is carried out under vacuum to improve the evaporation and condensation processes. The latent heat is supplied by the feed liquid and the heating fluid in the heat exchanger and vapor is generated over the water film 17. Vacuum is applied to the vapor stream. The vacuum reduces the air content in the vapor over the evaporation and condensation surfaces and improves the evaporation and condensation heat transfer coefficients by reducing the resistance introduced by the non-condensable gases, such as air. The air may be present in the system components and piping, etc. or it may be released from the feed liquid. It may contain other gases as well. The term vapor used in this disclosure includes gaseous mixture of pure vapor from the feed liquid and non-condensable gases which are released from the feed liquid as a result of heat and vacuum. Mechanical forces, including but not limited to centrifugal forces, can also be applied to remove the dissolved gases from the liquid or lower the pressure. Gravitational liquid head may also be used to create vacuum in desired locations.

The feed liquid enters at a temperature that is subcooled or superheated corresponding to the evaporation pressure over the evaporation plate. The excess superheat in the feed liquid causes evaporation. If feed liquid is sprayed, the excess superheat causes evaporation. Further, heat supplied by the heat exchanger provides latent heat for evaporation from the feed liquid.

The inclined plate 10 serves multiple purposes. It provides microstructures or surface features to distribute the feed liquid uniformly or in any desired pattern to promote distribution, evaporation, or both. The surface may contain microstructures or nanostructures including nanopores, wicking structures, transverse, longitudinal, short length or entire plate length or width sized grooves, turbulence promoters, mixing promoters, projections, straight or angled diverters, liquid spreaders, etc. The grooves and fins may be rectangular, symmetric or asymmetric microchannels, continuous or non-continuous, the grooves may contain sharp or rounded edges, sintering, electrodeposition, coatings, porous coatings, coatings with pores and tunnels, etc. The evaporation plate may be covered with material or fabric to provide wetting, liquid distribution or enhanced evaporation for improved performance. Surface tension, inertia and gravitational forces may be used to distribute the feed liquid and improve performance.

The flow rate of the feed liquid and the evaporation rate are determined by the concentration limits of the inlet and exit feed liquid streams. The concentrations are determined by the concentration in the feed liquid, desired concentration limit in the exit feed liquid stream, crystallization limit, vapor pressure characteristics which may depend on the concentration, or other operating considerations such as ability to provide uniform distribution, etc.

An open microchannel or minichannel can be used with a gap over the heat exchange surfaces in the evaporator. Tall fin structures, either continuous or interrupted, may be incorporated on the heat transfer surface of the evaporator. The height of the fin structure may be 100 micrometers to 5 cm and may be different at different sections. This gap can change in the flow direction to achieve the cross-sectional area changes desired. These channels provide a high heat and mass transfer coefficient to achieve high evaporation rates at low temperature differences and with a low pressure drop penalty. With a high shear stress present from the vapor flow, the operation of the evaporator may be designed to account for both the gravitational and shear forces in achieving liquid flow and evaporation. The microchannels may be used on both base plate and cover, both may incorporate heat exchangers to accomplish a compact evaporator design. The cover may also be an evaporator plate.

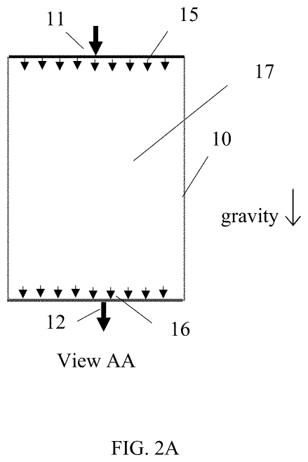

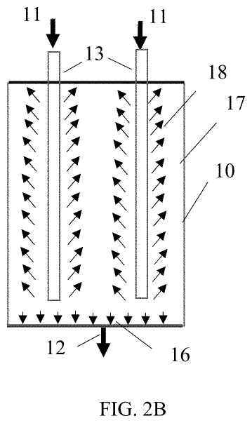

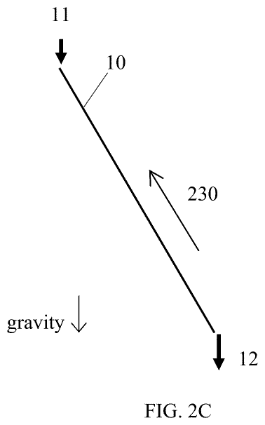

FIG. 2A details:
15—Feed liquid distributor
16—Liquid flow over the plate and collection
17—Front of inclined plate covered with feed liquid film or stream, the plate surface may have surface features for improving evaporation rate and for achieving proper liquid distribution on the inclined plate

FIG. 2B details:
13—Single or multiple feed liquid spray distributor pipe
14—Single or multiple spray streams from spray distributor pipe

FIG. 2C details
230—vapor flowing over the plate 10
τ_{V}—shear stress induced by vapor

FIG. 2A shows the front view AA of the evaporation plate 10 shown in FIG. 1. Feed liquid 11 is distributed with a distributor 15 over the evaporator plate 10 forming a layer or film of liquid. The feed liquid evaporates over the evaporator plate and is collected by the collector 16 and leaves the evaporator plate at 17.

FIG. 2B shows an exemplary system with spray distribution on the evaporation plate. 13 is the spray distributor pipe that feeds the spray nozzles in the pipe to provide spray 14 from the pipe onto the inclined plate. The evaporation plate may have any angle to the vertical from 0 to 90 degrees and may face up or down. A liquid droplet separator may be incorporated in the vapor stream prior to entering the condenser with any feed system. This will prevent carryover of the feed liquid into the condenser. Any other type of liquid distributor may be implemented.

FIG. 2C shows the evaporated vapor 230 flowing over the heat transfer surface in a large cross-sectional area evaporator.

The outlet liquid collector from the evaporator may be employed to collect the liquid and discharge it as a single stream to a collection tank or a vessel.

The evaporation process may be enhanced by the surface features. The liquid distribution may be promoted using the surface features. The surface features on the evaporator plate promote the heat transfer process from the plate to the flowing feed liquid. The heat transfer results in evaporation. Evaporation is promoted by the surface features. The surface features reduce the interfacial resistance or lower local liquid pressure during the evaporation process through the capillary forces. These features reduce the evaporation resistance and increase the evaporation rate.

The distributor 15 and collector 16 provide distribution of the feed liquid and its collection. The distributor is introduced to provide uniform distribution. The inlet distributor may introduce swirl, turbulence, or other flow features to help in the distribution and evaporation processes.

The distributor can be of any other type. It can be a spray type in which the inlet feed liquid is sprayed or dripped on the plate using spray or dripping feeder tubes. In an exemplary system, a single tube or multiple tubes with spray nozzles are placed in the vapor space to provide the feed liquid on the evaporator plate. A separate pump may be utilized to provide the spray, or the pressure differential between the available feed liquid stream and the evaporator pressure may be utilized to accomplish the spray.

The evaporator plate may be inclined to vertical from 0 degrees to 90 degrees. A preferred range is from 1 degree to 85 degrees, more preferred range is from 5 degrees to 80 degrees, further preferred range is from 10 degrees to 50 degrees. The plate may of any shape and size, including rectangular, circular, any regular or irregular shape, etc. The plate may be flat, wavy, or may contain undulations, dimples, etc.

In one exemplary configuration, the evaporator plate may be horizontal or inclined and face downward while the feed liquid is sprayed over it. Some of the feed liquid evaporates while the remaining flows or falls down from the plate.

Different feed liquid distribution systems may be implemented either individually or in combination with each other. The plates may be of any shape or contour, meaning that they may be plane, wavy or any other configuration.

The vapor flows over the liquid film while the liquid film simultaneously exchanges heat from the evaporator heat exchanger, and evaporation takes place from the liquid film. In an exemplary configuration, the evaporation occurs while the feed liquid flows over a surface that is not being heated by the heating fluid. In another exemplary configuration, the heating of the feed liquid is accomplished by other heating methods, including solar radiation, electric heating, etc. FIG. 2C shows the flow of vapor over the plate. The vapor may flow in the direction shown or in the opposite direction. The vapor induces a shear stress τ_{V} over the liquid film that is flowing over the plate. This shear stress causes disturbance on the film surface and enhances mixing in the film and increases the evaporation rate. The vapor flow also induces a wall shear stress that enhances heat transfer from the plate to the liquid film.

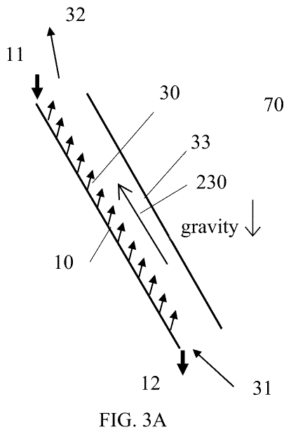

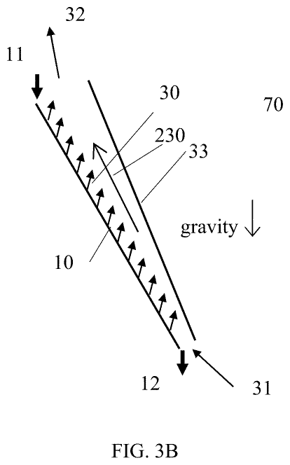

FIG. 3A details:
30—Evaporation from the liquid flowing on the plate
31—Inlet vapor stream
32—Outlet vapor stream
33—Evaporator cover
70—Evaporator
230—Vapor flow between the plates 30 and 33

FIG. 3A shows the evaporator 70 in which evaporation takes place. A cover plate 33 is placed above the inclined plate 10 creating an evaporated vapor passage from which the vapor 32 exits. The sides between the cover plate and the heat transfer surface may be closed to form channels. Similar configuration of the closed side walls to form channels may be implemented in the condenser. Vapor may flow into the evaporated vapor passage in the vapor stream 31. Feed liquid enters at 11 and exits at 31. A cover plate 33 encloses the evaporation region. It is shown parallel to the evaporation plate. This arrangement gives a constant distance between the two plates and a constant cross-sectional area from inlet to outlet cross-sections. Vapor flow 230 in the internal flow cross-section introduces a shear stress on the film. The vapor flow at 32 is greater than the vapor flow at 31. This causes vapor velocity to increase as the evaporation generates more vapor from the liquid film as the vapor travels from the section 31 to the section 32. The vapor shear also increases in the vapor flow direction.

The vapor shear causes disturbances on the liquid film which result in waves. As the vapor velocity increases, liquid is sheared off from the film and liquid droplets are entrained in the vapor. This is not desirable as the saline water droplets may travel along with the vapor into condenser and mix with the condensate water.

FIG. 3B shows a tapered gap formed by the plates 33 and 10 with gap increasing in the vapor flow direction shown by 230. Vapor 31 may also enter the evaporator passage. The vapor velocity in the narrow gap is maintained high to disturb the film flow and improve the heat transfer to the liquid film at the plate 10 and at the evaporating liquid-vapor interface. The evaporating plate is inclined as shown to the gravity vector to allow formation of film and its flow over the plate 10. The plate 10 may have enhancement features for improving heat transfer. The plate 10 may have features to facilitate uniform liquid film distribution and prevent dryout or streaking effect. These features include porous coatings, microstructures, grooves, ridges, fin-like projections, turbulators, hydrophilic coatings and other features to promote the evaporation rate. These features may also be designed to avoid salt crystallization.

Provision of the evaporated vapor passage is an important element of the disclosure. The passage is formed by confining the evaporator into a space bounded by other adiabatic or evaporator plate or surface to allow for the flow of the vapor in a confined space. The space may be formed within two plates with evaporation occurring over one or both surfaces. The edges on the two sides of the plates where a feed liquid inlet or outlet is not located, may be closed to form the vapor flow passage or passages. This passage creates a flow of vapor over the evaporator plate. The resulting vapor shear and other flow effects such as wave propagation, film thinning, etc., multiple contact lines, etc. improve either or both the evaporation process from the feed liquid interface and the heat transfer process from the inclined plate to the feed liquid flowing over it.

The cover plate 33 in FIG. 3B is not parallel to plate 30 and forms a tapered gap between the two plates. This taper gap increases in the vapor flow direction as new vapor is added to the flow. The taper can be controlled such that the vapor velocity is kept at a desired value, or within a desired range. This range is determined by the enhancement in heat transfer and enhancement rates and by the limits of wave generation and droplet ejection or any other considerations.

The tapered channel causes the flow to accelerate in the direction of the larger cross-sectional area. Any reduction in static pressure due to flow velocity results in lowering of the saturation temperature and improves the evaporation rate from the evaporator plates.

Evaporated vapors flow in the passage towards the outlet in the stream 32. As the vapor moves towards the exit, more vapor is evaporated and the flow velocity increase along the flow direction if the cross-sectional area of the flow passage is held constant, neglecting any changes in the liquid film thickness which is expected to be quite small as compared to the vapor flow cross-section. The flow passage cross-sectional area normal to the vapor flow direction is made to increase to limit the increase in vapor velocity. At very high velocities, the liquid may be stripped from the evaporator plate or it may splash. The vapor velocity is controlled within a desired range by increasing the gap, which is defined as the distance at any cross-section normal to the evaporator plate, in the flow direction. The gap is kept smaller at the inlet and is larger at the outlet. The increase in the gap may be uniform or in a stepped fashion. The gap may follow a wavy pattern to provide variation in the vapor flow velocity. These features may be introduced to provide increased turbulence or mixing. They aid in improving the evaporation process, and the heat and transfer processes. The gap size is determined by the desired vapor flow velocities. The average vapor flow velocity over a cross-section along the vapor flow path depends on the length of the evaporator plate in the vapor flow direction, evaporation rate, liquid and vapor properties which further depend on the pressure. The gap also depends on the overall system size. The gap may vary from 1 mm to 200 mm, or larger for large evaporators that are over a meter long. The evaporator and cover plate may contain features to modulate the vapor flow for improving the overall system performance, improve the evaporation and heat transfer processes, or from other operational considerations such as descaling, periodic cleaning, etc. It may contain some features to incorporate mechanical devices such as stirrers, scrapers, etc.

The plate 10 may contain open microchannels, open minichannels or other microstructures. Combination of narrow passages and taper provides the enhancement in both heat transfer from the plate to the film, and evaporation rate from the flowing liquid.

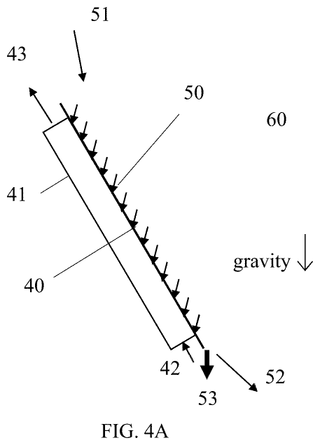

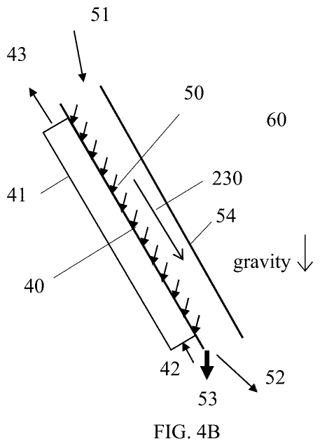

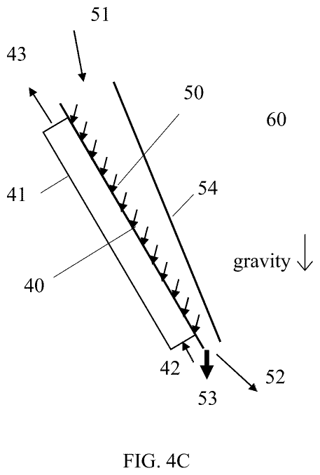

FIG. 4A details:
40—Condensation plate
41—Condenser heat exchanger
42—Coolant inlet
43—Coolant outlet
51—Vapor inlet
53—Condensate stream
54—Condenser cover plate
60—Condenser

FIG. 4A shows a condenser 60 with an inclined condensing plate, also called a condensation plate 40, a condenser heat exchanger between cold fluid and the condensing vapor 50 on condensation plate 40. Cold fluid enters at 42 and leaves at 43 in the condenser heat exchanger. Vapor 51 enters the condenser and the condensed liquid leaves at 53. Although the condensing surface is shown to be facing upwards, an upwards facing condensing plate may be implementing. The condensing surface may be vertical. It has an advantage that the condensed liquid will fall down in the flow stream due to gravity. A lower film thickness on the condenser plate is desirable as it results in a high heat transfer rate due to reduced thermal resistance due to the film. A liquid-vapor separator may be included at the exit. A liquid-vapor separator may be included in the system at any location to prevent the cross mixing of feed water and condensate.

Condensing liquid drains by gravity over the plate. The system may be designed to accomplish the drainage using other forces, for example, capillary and interfacial shear forces. The condensing plate may be vertical or inclined to vertical in either directions, meaning the condensation may occur over upward facing or downward facing surfaces. Condensation may occur over a vertical or a horizontal surface. Since the condensate needs to be drained away, the slope of the inclined plate facilitates in the condensate removal due to gravitational forces. When the condensate plate is facing upward, the condensate drains over the plate by gravity. It is desired to keep the condensate film thin to reduce the thermal resistance introduced by the condensate film. The condensate film may be facing downward. This configuration allows condensate to fall off from the condensate plate by gravity. Efficient removal of condensate from the plate improves the thermal performance in terms of higher condensation heat transfer coefficient and higher condensation rate for a given coolant temperature.

FIG. 4B details:
50—Condensation on the condensation plate
51—Vapor inlet
52—Vapor outlet
54—Condenser cover plate

FIG. 4B shows a condensation cover plate 54 placed over the condenser plate 50 forming a passage for vapor flow 230. The plate 54 is shown to be parallel thereby providing a constant gap and constant cross-sectional area for vapor flow between plates 50 and 54. The vapor flow induces a shear stress on the condensate film and condensate droplets. This causes the condensate film to drain more efficiently and the film thickness is reduced. This improves the heat transfer rate and condensation rate. The condensate passage gap, defined similar to that in the evaporator, is the distance measured normal or perpendicular from the condensation plate to the cover plate at any location. The cover plate may also be another condensation plate. In one exemplary configuration, the cover plate may be an evaporator plate, in which case care needs to be taken to avoid mixing of the feed liquid and the condensate streams. Care also needs to be taken to keep the excess feed liquid stream separate from the condensed liquid exiting the condenser. The gap determines the cross-sectional area available for vapor flow at any section along the vapor flow direction. The vapor velocity is kept at a high value to introduce sufficient vapor shear which disturbs the condensate film and causes it to thin or cause the condensate drops to be removed from the condensing surface. The vapor shear improves the condensation heat transfer coefficient and aids in the efficient removal of the condensate from the condensation plate.

The vapor shear is also important in reducing the thermal resistance introduced by the non-condensable gas layer that is left behind. The vapor shear will cause this layer to become thin. It also improves the diffusion of non-condensable gas from the liquid-vapor interface into the core vapor stream. This improvement is applicable to the presence of air in the vapor. It is also applicable to the case where air is replaced by helium. Similarly, it is also applicable to the case where air is replaced with air-helium mixture. A flow of vapor or gas parallel to the heat exchanger surface induces a shear stress. The increased flow velocity will improve the condensation rate in all cases, including air-vapor mixture, helium-vapor mixture, and air-helium-vapor mixture, over the case where the velocity is zero as in the case of natural condensation or where the velocity is low.

The condensate plate may contain features to improve either the condensate removal or enhance condensation rate. It may contain grooves, hydrophobic surfaces, hydrophilic surfaces, combination of different wettability surfaces, or other microstructures, nanostructures, fins, dimples, ridges, etc. which facilitate removal of the condensate and improve the condensation heat transfer coefficient. Some of the features may also affect the heat transfer coefficient from the coolant to the condensation plate. In the case of a downward facing condensation plate, it may contain surface features that promote liquid to fall off from fins or projections. These surfaces may be coated with hydrophilic coatings to promote formation of liquid films or may be coated with hydrophobic coatings to promote dropwise condensation or liquid ejection from the surfaces. The surface may contain nano and microstructures, multiscale heat and mass transfer enhancement features, or other active or passive means to improve the heat and mass transfer rates and condenser performance.

FIG. 4C details:
54—Condenser cover plate at an angle to condenser plate 40

The condenser cover plate 54 in FIG. 4C is not parallel to condenser plate 40 and forms a tapered gap through which vapor flows. These narrow channels formed between the cover plate and condenser plate provide an efficient heat transfer and condensation system. The vapor shear helps in improving the heat transfer performance while the tapered cross-section allows to keep the vapor shear over the condensation plate and the condensate liquid at a desired high level.

Another important feature of the present disclosure is the flow of vapor in the passage created by the condensing plate and the cover. A high velocity is maintained to reduce the condensate film thickness, introduce waves, remove condensate, reduce the adverse effect of non-condensable gases, or to introduce any specific feature to achieve higher heat and mass transfer performance. Improving performance helps in reducing the size of the equipment and also helps in improving the process and cycle efficiency. The condensing plate may incorporate open microchannels or open minichannels.

A constant passage gap will result in a constant vapor flow cross-sectional area. Since the vapor mass flow rate decreases along the flow direction due to condensation, a constant cross-sectional area will lower the vapor velocity along the flow length. To increase the vapor flow velocity, the gap may be kept small. To keep the vapor velocity high, the gap is further reduced in the flow direction. This reduces the flow cross-sectional area with decreasing vapor flow rate. The area reduction may be implemented in a gradual or a stepwise fashion, although a gradual change will incur lower pressure losses. For the same exit pressure, this will allow for a lower pressure at the entrance to the condenser.

In one exemplary embodiment, the condenser is composed of two inclined plates to provide a constant or varying cross-sectional area to the vapor flow. Cold liquid, which is the condensate product itself, is sprayed in the vapor stream. Direct contact condensation is accomplished while the liquid drains away. The condensate spray may be directed across, along or in the opposite direction to the vapor flow. Maintaining the vapor velocity at the desired level is accomplished through the tapered gap. The high relative velocity between the spray droplets and the vapor increases the heat and mass transfer coefficients. Direct contact condensation with an outlet for non-condensed vapor provides a very high performance as the condensation surfaces in a traditional condenser heat exchanger configuration suffers from the buildup of non-condensable gases over the condensing vapor-liquid or vapor-solid interface.

The arrangements for evaporators and condensers presented in this disclosure take advantage of the flow of the vapor to improve the evaporation or condensation rates. This feature makes the equipment very compact. The volume of vapor in the system is also kept low by having confined passages and small connecting regions between the evaporator and condenser. This reduces spaces where non-condensable gases can accumulate.

The vapor in the evaporator and the condenser flows over plates that provide evaporation and condensation processes respectively substantially over the flow passages in the respective units. Specifically, these arrangements are not to be confused with baffles or louvers that are sometime placed to direct vapor in equipment such as in cooling towers and provide multiple vapor flow paths. Such baffles and louvers may cause an increase in the local velocity. The present disclosure utilizes narrow passages with suitable variation of the cross-sectional area such that the velocity is maintained within high limits necessary to induces heat and mass transfer enhancement or desired film flow patterns such as drainage or turbulence, etc. There are no multiple flow paths created by the covers, or the evaporation and condensation plates.

The gap dimension and its variation along the vapor flow length are chosen based on the condensation rate, overall size and length of the condenser plate, vapor and liquid properties, and the operating pressure. Similarly, the gap dimension and its variation along the vapor flow length is chosen based on the evaporation rate, overall size and length of the evaporator plate, vapor and liquid properties, and the operating pressure.

The condenser may be operated under vacuum. Lowering the vacuum and removing non-condensable gases improves the heat and mass transfer coefficients. Removing non-condensable gases removes the heat and mass transfer resistance due to these gases at the interface. As vapor condenses out, the non-condensable gases remain behind and their concentration increases and results in a performance degradation.

In humidification-dehumidification systems, the evaporation and condensation processes are carried out in the presence of air. Implementing the tapered flow channels in evaporator and condenser will individually and together improve the performance of a humidification-dehumidification system using air. Although the partial pressure of water vapor in the case of a desalination application is reduced in the presence of air enabling lower temperature heat to be used for the evaporation process, the air presents a mass transfer and heat transfer resistance especially in the condenser. By operating the system at lower pressure, or at a vacuum, the evaporation temperature is reduced. Similar effect is obtained by using humidification-dehumidification system. Removal of non-condensable gases with a high velocity vapor stream improves the heat and mass transfer coefficients. This leads to more compact equipment and a more efficient system as compared to humidification-dehumidification systems that do not incorporate the tapered flow channels especially in the condenser.

One of the drawbacks of the vacuum systems is the need for an additional device to reduce the pressure and create vacuum. This can be accomplished with a vacuum pump, an ejector system, or any other suitable system.

Combining vacuum with the vapor flow benefits both the evaporator and condenser in improving the heat and mass transfer coefficients. Smaller cross-sectional passage dimensions achieve desired vapor flow velocities which range from 0.1 m/s to 100 m/s in desalination applications. These are also applicable to humidification-dehumidification systems. The evaporator and condenser described in this disclosure can be applied in any type of desalination plant where evaporation condensation processes are used including in humidification-dehumidification based systems. Higher velocities may be implemented for large systems producing 100 liters or greater amount of condensate in a day. Smaller velocities may be implemented to avoid disruption to the liquid film flow. The flow of vapor on the heat and mass transfer surfaces of a plate or a spray prevents the buildup of non-condensate gases over these surfaces. Another consideration is the pressure drop incurred, which increases with vapor flow velocities. A higher-pressure drop is not desirable as it lowers the required condensation temperature and reduces the system efficiency.

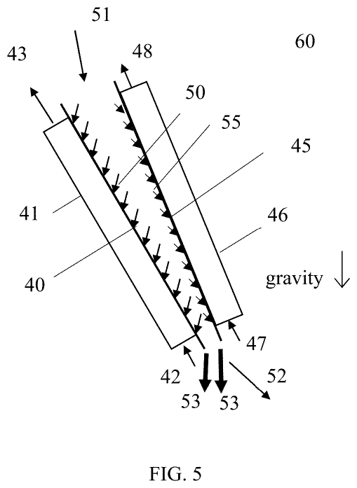

FIG. 5 details:
40—Lower condensing plate
41—Lower condenser heat exchanger
42—Coolant inlet
43—Coolant outlet
45—Upper condensing plate
46—Upper condenser heat exchanger
47—Coolant inlet
48—Coolant outlet
50—Condensation on the lower condenser plate
51—Vapor inlet
52—Vapor outlet
53—Condensate outlet
55—Condensation on the upper condenser plate

FIG. 5 shows an exemplary design in which two condenser plates are incorporated in one condenser 60. The lower plate 40 is facing up and the upper condensing plate is facing downwards. Condensate on the lower plate 40 drains as a film 50 while condensate on the upward facing plate partially flows as a film and partially as falling droplets or streams 55. The lower condenser 41 has cooling fluid inlet and outlet streams 42 and 43 respectively. The upper condensing plate has condenser heat exchanger 46 with cooling fluid inlet and outlet streams 47 and 48 respectively. Condensing liquid droplets or stream 53 leave the condenser. Vapor 51 enters the condenser and remaining vapor along with higher concentration non-condensable gases in them leave the condenser. The systems when operated with a non-condensable gas present in the system, the vapor stream may contain gas also and represents vapor and gas mixture in all embodiments.

Incorporating two condensate plates in the condenser makes it more compact. The angle between the two plates is such that the gap reduces in the flow direction. The angle between the plates is between 0 degree and 20 degrees, or more preferably between 1 and 15 degrees, or other angles as described elsewhere in this disclosure. When the vapor velocity is high, the condensate drainage may not be dependent on the gravitational orientation and any angle may be used without regard to gravitational orientation. The angle depends on the size and length of the condensation plates in the vapor flow direction. Individual plates may be downward facing or upward facing. In one example, additional cover plates may be incorporated to create flow passages that provide the desired variation in the gap along the flow direction. Although the examples shown here have the condenser plates in specific upward and downward facing configurations, the condenser can have one or both plates in upward or downward directions. The vapor flow direction could also be upward. Specific features to remove liquid from the plate and fall by gravity from downward facing plate is also included. Any variation in the coolant inlet and outlet direction with respect to the vapor flow direction can be implemented. The two plates may be served with same coolant streams or from different coolant streams. When two plates serve as condensing plates in the same evaporator, it is called as dual plate condenser.

The evaporator heating fluid in the evaporator heat exchanger can also flow along the same or opposite direction as the vapor flow direction in the evaporator. When both plates are used for evaporation heat transfer, it is called a dual plate evaporator. The heating fluid streams serving different evaporator plates, in the same evaporator or in different evaporators may be operated in series or in parallel. They may have heat source in between the two evaporators. In multistage operation, the condensate may act as heating stream in subsequent stages where the temperature ranges are suitably matched between the evaporator and heating streams. Similarly, the feed liquid stream can be utilized in multistage systems in evaporator or condenser. Other energy saving strategies may be incorporated between the heating and cooling sources and the liquid feed and condensate streams.

The system of evaporators and condensers can be used in multistage configuration. Different stage evaporators and condensers can be coupled with each other and other system components such as heating or cooling sources, flow dividers, etc., to improve the overall system efficiency or efficient operation or maintenance. The system pressure, or the vacuum in each evaporator and condenser could be adjusted from these or other considerations.

The average velocity of vapor at any cross section within the evaporator or condenser depends on the flow rates of vapor and feed liquid streams, system pressure, vapor density, fluid properties and cross-sectional area. The vapor velocity is an important consideration in both the evaporator and condenser. A higher flow velocity imparts a higher shear stress on the liquid film and promotes its thinning and droplet shear-off. The desired velocity ranges from 0.1 m/s to 100 m/s. A major difference between the present disclosure and other systems where vapor velocities are present is that the current system is designed to take advantage of the vapor shear stress to improve the heat transfer coefficients in condenser or evaporator, promote turbulence, promote mixing, promote fluid flow, promote liquid film reduction, etc.

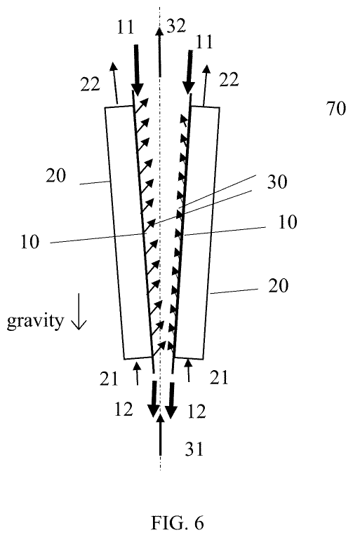

FIG. 6 details:
10—Inclined plate for evaporation
11—Feed liquid in
12—Feed liquid out
20—Evaporator heat exchanger
21—Heating fluid in
22—Heating fluid out
30—Evaporation from the liquid flowing on the plate
31—Inlet vapor stream
32—Outlet vapor stream

FIG. 6 shows an exemplary embodiment of an evaporator 70. Both the plates forming the vapor flow passage are heated. Both plates in this embodiment are inclined in such a way that they provide upward facing surfaces for film flow and evaporation. The liquid feed distribution from the inlet feed streams 11 provides a film flow over the inclined surfaces. Evaporation takes place over the liquid-vapor interface. A feed liquid spray system can be added to this embodiment or it could replace the feed distribution shown in FIG. 6. Other techniques for distributing liquid over the plate may be incorporated. The feed stream may be heated before inlet to a higher temperature to increase evaporation rate and make a more compact design thereby improving vapor generation rate for a given volume of the equipment. In another embodiment, the superheat of the feed liquid is used to supply at least some of the latent heat required for vaporization.

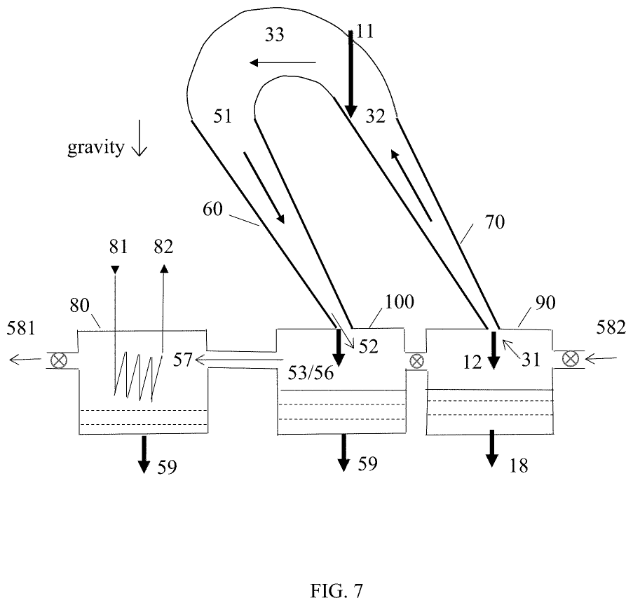

FIG. 7 details:
11—Feed water distributed in the evaporator
12—Excess feed water
18—Brine outlet
31—Vapor entering the evaporator
33—Vapor flow from evaporator to condenser
51 Vapor entering the condenser
52—Vapor from condenser, consists of mixture of uncondensed vapor and non-condensable gas
53—Condensate from condenser
57—Vapor to secondary condenser
581—Outlet with a valve
582—Inlet with a valve
59—Condensate outlet
60—Condenser
70—Evaporator
80—Secondary condenser
90—Excess feed water tank
100—Condensate tank

FIG. 7 shows an evaporator 60 and a condenser 70. Vapor 31 enter at 32 exit evaporator 60 and travel towards condenser 70 as a vapor stream 33. Vapors then enter condenser at 51 and condense on the heat and mass transfer surfaces provided by heat transfer in heat exchangers or in a direct contact fashion. Exceed feed liquid 12, called brine is collected in a tank 90 and is removed at 18.

FIG. 7 shows is an exemplary embodiment of a system for producing pure component distillate from a solution. A preferred application of such system is in a desalination application where pure water is produced from a saline solution such as sea water or brackish water. The solution may contain non-solubles in which case additional cleaning strategies are employed to prevent the buildup of the non-solubles on the heat and mass transfer surfaces. Such non-solubles may block the spray systems or deposit on evaporation surfaces with detrimental effect on evaporation and feed liquid flow and should be considered in the design and operation. Precipitation of solutes from the feed liquid is also an important consideration in the design of the feed rates, temperature ranges for operation, surface areas provided for the transfer processes, etc.

Condensates 53 exit the condenser 60 and are collected in a container 80. Condensate 59 is removed from the container. Vapor that are not condensed exit as 52. These contain a higher concentration of non-condensable gases. These vapors 57 flow into a secondary condenser 80 where a coolant is circulated with 81 and 82 streams on condenser surfaces. Additional vapor is condensed and is removed 59 from the secondary condenser 80.

Vapor and non-condensable gases 581 are removed from condenser 80. The valve at 581 provides for gas removal as desired. This is accomplished using a vacuum pump or any other arrangement such as gravity head, ejector pump, etc. This makes the system operate under vacuum and remove non-condensable gases from the heat and mass transfer surfaces in the condenser. Purging of the non-condensable gases is an important aspect to prevent the condenser performance from degrading due to the mass transfer resistance from the buildup of non-condensable gases. The total volume of the system is kept low by keeping the flow passages in the condensers and evaporators small and the connecting pipings, if present, between the evaporator and condenser small as well. This helps in reducing the evacuated volume especially during start-up and batch-type operation. Also, during continuous operation with vacuum, undesirable pockets of higher concentration non-condensable gases is avoided. The exit of the evaporator may be directly connected to the condenser inlet. Flow resistance to the vapor is kept low in the connecting passages as the operating saturation temperature depends on the pressure and the performance of both evaporators and condensers are adversely affected from the energy efficiency standpoint.

The inlet 582 with a valve provides for inlet of gases during charging or the recirculation stream coming from 581. The system may incorporate fans and blowers at various locations to accomplish vapor movement as needed. Liquid pumps may also be incorporated as needed. Pumps may be used to replace gravity dependent flow shown at different locations. The connection 582 may be used for charging with different gases, as desired. Optional connections may be made for outlet gases from 581 to be recirculated into the system at 582. Partial replenishment may be done for the exhaust gases with fresh gases. The system may have additional sensors and controls that are not shown for reading, monitoring, and controlling the gas composition, pressure, liquid levels, flow rates, fans, and blowers, etc. within the system. The flow rates of different streams can be controlled using the sensors and design settings for exit feed stream concentration, humidity ratio levels within the system, etc.

The passage between the evaporator and condenser 33 should be designed carefully to avoid pressure losses in this section. Since the exiting vapor from the evaporator is at a high velocity, and the velocity at the entrance to the condenser in the tapered channel is also desired to be high, care should be taken to keep the velocity in 33 to be high and passages should be designed with minimum flow obstruction and short flow lengths in this section.

The system shown may be operated in an exemplary manner as a desalination system using humidification-dehumidification process by opening the valve between 90 and 100 so that the carrier gas or gas mixture is recirculated. A fan may be added to help the flow of gases through the heat exchangers in the stream 33. The fan may be placed at another location to accomplish the gas and vapor circulation. One of the tapered heat exchangers may be replaced by another type of heat exchanger. The taper may be reduced to zero or negative taper depending on the desired system operation.

Although the embodiment shown in FIG. 7 is shown to contain specific features and specific orientations, any combination of the features disclosed herein can be implemented. As an example, multiple units of evaporators and condensers, or multiple combined units of evaporators and condensers can be implemented with cascading for the feed streams, coolant streams, heating streams, or vapor flow streams. Multiple secondary condensers at different locations may be incorporated to remove the non-condensable gases and maintain the vacuum in the system.

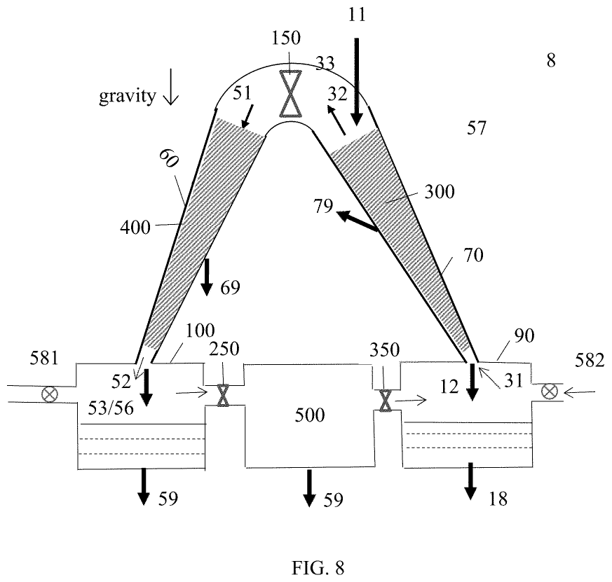

FIG. 8 details:
11—Feed water distributed in the evaporator
12—Excess feed water
18—Brine outlet
31—Vapor entering the evaporator
33—Vapor flow from evaporator to condenser
51 Vapor entering the condenser
52—Vapor from condenser is a mixture of uncondensed vapor and non-condensable gas
53—Condensate from condenser
57—Vapor to secondary condenser
581—Outlet with a valve
582—Inlet with a valve
59—Condensate outlet
60—Condenser
70—Evaporator
80—Secondary condenser
90—Excess feed water tank
100—Condensate tank
150, 250, 350—Fan or blower
300—Heat exchanger to evaporate feed liquid 11
400—Heat exchanger to condense vapor
69—Intermediate outlet for condensed water
79—Intermediate extraction of vapor
500—Auxiliary processing unit

FIG. 8 shows another embodiment of the present system. It is designed to reduce the pressure losses during vapor flow by limiting flow length and directional changes low. It utilizes heat exchangers such as a compact plate fin or tube-fin or any other type of heat exchanger which can facilitate evaporation from feed water liquid distributed over the heated heat exchanger surface in 300 and condense vapor in 400. The heat exchangers are suitable for flow evaporation and flow condensation in the vapor passages. The evaporator may include an arrangement to distribute feed water over the heat exchanger surfaces to facilitate evaporation. The condenser may include an arrangement to remove condensed water from the heat exchanger surfaces. The heat exchangers may be individual units that are arranged such that they provide a stepwise flow rate in the heat exchangers. Vapor and condensate may be extracted at intermediate points during evaporation and condensation, respectively. Evaporator and condenser heat exchangers may be arranged in series or parallel arrangements. The effect of taper may be achieved by adjusting the number and arrangement of series and parallel heat exchanger components. For example, two heat plate-fin type heat exchangers with feed water distribution system may be placed in series with an intermediate vapor extraction point so that the vapor velocity in each evaporator heat exchanger is maintained in the desired limit of velocity. The desired velocity will depend on the type of heat exchanger used and is set to accomplish high heat transfer coefficient without having high carryover of the feed water in the vapor stream, and without causing dryout patches or regions and performance deterioration. Additional parallel arrangements of heat exchanger evaporators may be added in a system. In a condenser, for example, two heat exchanger condensers may be operated in parallel followed by condensate extraction and only one heat exchanger evaporator as the vapor flow rate is reduced. In another embodiment, vapor may be added at intermediate point to keep the velocity high without reducing the number of heat exchanger evaporators working in parallel. Any combination of series and parallel arrangements coupled with intermediate vapor extraction and intermediate feed water supply in the evaporator and intermediate condensate extraction and intermediate vapor supply in the condenser may be incorporated. The step-wise change in velocity, maintaining vapor velocity within desired limits, vapor extraction, vapor supply, and condensate extraction and feed water supply, series and parallel arrangements of heat exchanger components, designing vapor flow passages within a heat exchanger to take advantage of taper in maintaining velocity within certain limits, are all features that are included in the present disclosure.

The auxiliary unit 500 incorporates heat exchangers, not shown, with supply of heating or cooling medium to accomplish a variety of processes including but not limited to, heating of the vapor, dehumidification, vapor condensation, mist removal, and any other psychrometric or heat transfer process or processes. For example, the vapor, which may include water vapor and non-condensable gases, are heated in this unit before they are circulated back to the evaporator unit in stream 31. The processes within 500 may be done serially or in parallel. For example, the condensate 59 from 500 may be removed in the condensing unit, while the remaining vapor is heated in a heating unit. Any other heat and mass transfer process may be accomplished. The auxiliary unit 500 may be combined with other units such as 100 or 90 for example, or it may replace some other units.

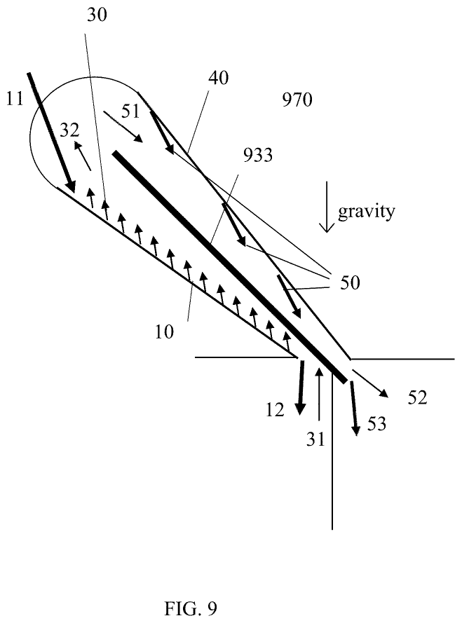

FIG. 9 details:
10—Evaporation plate
11—Feel liquid in
12—Feed liquid out
30—Evaporation from the liquid flowing on the plate
31—Inlet vapor stream
32—Outlet vapor stream
933—Evaporator-Condenser separator plate
40—Condensation plate
970—Evaporator-Condenser Unit
50—Condensation on the condensation plate
52—Vapor outlet

FIG. 9 shows an exemplary embodiment in which some of the components described herein are combined. Other types of combinations are possible. The evaporator and condenser are combined. The liquid is fed in at 11 on an evaporation plate 10. Excess feed liquid that is not evaporated leaves at 12. Evaporation 30 occurs on the evaporation plate. An inlet vapor stream 31 may enter the evaporator. The evaporated vapor stream 32 leaves the evaporator and enters the condenser as vapor stream 51. The vapor condenses on the condenser plate 40, which is cooled by an external coolant, not shown. The condensate flows down toward the condenser outlet and leaves as condensate stream 53. In the case where the evaporator is downward facing as shown in FIG. 9, the condensate may fall on the separator plate 933 which separates the evaporator and condenser sections. The separator plate is insulated so that the vapor generated in the evaporator do not heat up and evaporate the condensate stream and the vapor does not condense on the underneath of the separator plate, which acts as the cover for evaporator side channel as well as the cover for the condenser side channel. This combined unit 970 provides a compact unit that combines the evaporator and condenser components and contain very low vapor volume. The separate plate may have holes or slots for vapor passage from evaporator to condenser side, and care should be taken to ascertain that the condensate does not flow from condenser side to evaporator side.

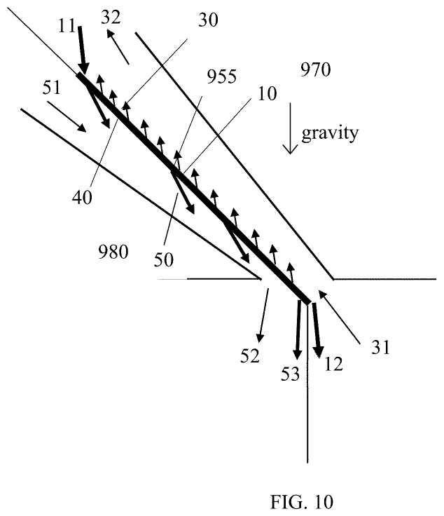

FIG. 10 details:
970—evaporator in the lower pressure stage in a desalination system
980—condenser in the higher-pressure stage in a desalination system

The heat rejected during the condensation process in the higher-pressure stage can be utilized to evaporate liquid from the lower pressure stage in a multistage desalination system. An exemplary embodiment of such an arrangement is shown in FIG. 10. In falling film evaporation, increasing the liquid velocity improves the evaporation rate. The liquid velocity can be increased by increasing the liquid flow rate or by increasing the inclination angle of the evaporation plate. Increasing the inclination angle tends to reduce the film thickness and leads to streaking of the liquid flow thereby reducing the liquid coverage on the evaporation plate. However, increasing velocity leads to a higher liquid mass flow rate and lower fraction of liquid being evaporated. Another way to increase the evaporation rate without increasing the liquid velocity is to introduce an interfacial shear stress at the evaporating liquid-vapor or liquid-gas interface. If the vapor flow is in the opposite direction to the liquid flow, the effect of shear stress on improving the evaporation rate is more pronounced due to ripples and waves generated by the counterflow of liquid and vapor at the interface. An inclination angle of from 1 to 85 degrees to the horizontal is preferred for the evaporation plate with the plate facing upward for the film flow. A more preferred inclination angle is from 0 to 30 degrees, more preferred range is from 1 to 10 degrees, and further preferred range is 3 to 10 degrees.

The zero velocity may exist near the liquid exit if there is no vapor introduced at this cross-section. A preferable range is from 0.5 m/s to 50 m/s. A more preferable range is from 5 m/s to 25 m/s. Another preferable range is from 10 m/s to 25 m/s. As the velocity increases, the evaporation rate increases due to improvement in heat transfer from the plate to the film and mass transfer coefficient at the evaporating liquid-vapor interface. Depending on the liquid and vapor properties such as density, viscosity and surface tension, the increased velocity may lead to wave formation and droplets shearing off from the interface which is not desirable due to carry-over of saline water with the vapor. Due to cumulative flow of vapor produced near the lower end of the plate with the vapor produced near the inlet, the vapor flow rate increases in the vapor flow direction. The taper angle between the plate and the cover is varied such that the velocity of vapor is maintained within the desired range. The combination of the taper angle and velocity is selected to provide the desired improvement in the heat transfer performance and evaporation rate without introducing liquid carryover effect. The preferred velocity ranges and the taper ranges are dependent on the evaporation rate per evaporator, length of the evaporator, plate inclination and other factors including fluid properties and pressure.

In one embodiment, vapor may be extracted from one side in which case a crossflow velocity of vapor is induced on the film. This also has the effect of improving the heat transfer performance. The vapor flow channel cross-section may have a taper such that the vapor cross flow velocity is maintained within the desired range. These velocities are in the same ranges as given for the pure counterflow case.

In another embodiment, the vapor and film flow may be in parallel flow in which case vapor and liquid exit at the same exit location. This arrangement does not introduce as much shear effect on the film and reduces the heat and mass transfer coefficients. Droplet carryover effect also may be less severe due to reduced interfacial shear.

In the case of a condenser, the vapor velocity ranges are similar to those given for an evaporator. The criteria for deciding the vapor velocity ranges in the condenser is dependent on the reduction in film thickness, removal of condensed water droplets, and removal of non-condensable gases from the condenser plate. A preferable range for vapor velocity in the condenser flow passage is from 0.1 m/s to 100 m/s. A more preferable range is from 1 m/s to 100 m/s. Another preferable range is from 5 m/s to 40 m/s, a more preferably 5 m to 25 m/s.

Although the description is given for plates, this concept is applicable to tubular or curved geometries. The taper may be incorporated by changing the tube diameter or other dimensions forming the cross-section along the flow length.

Another feature is that the volume of the individual heat exchangers is kept low as compared to these components employed in Multistage Flash (MSF) desalination processes or Multi-Effect Distillation (MED) processes. By keeping the vapor velocity in the desired range, both the gap size and the overall volume are reduced. The maximum vapor flow rate occurs at the evaporator outlet and the gap height is given by the vapor volume flow rate divided by the vapor velocity. The gap represents the ratio of evaporator or condenser volume per unit heat transfer surface area. The current system significantly lowers this volume-to-surface area ratio in desalination evaporators and condensers used in a desalination application. The lower volume is desirable since it reduces the cost of creating and maintaining vacuum in this equipment.

Multiple units of evaporators and condensers may be arranged to provide parallel or series operation. Multiple passages may be incorporated, each serving as individual evaporator or condenser. The inlet and outlet streams of different units may be combined to provide at least one of the features—compact unit, energy efficient unit, specific size restrictions, and operational ease.

The heat exchangers used may be of any type including plate fin, tube fin, plate heat exchangers, and any other types and combinations thereof. The heat exchangers may use heating and cooling fluids from any sources. It may also incorporate an intermediate heat transfer fluid for heating and cooling purposes.

The system utilizes flow velocity in a flow passage to improve the evaporation process. It also utilizes flow velocity to improve the condensation process. Also, the benefit of flow velocity on both evaporation and condensation processes in a combined system are utilized. The system aims to separate a liquid from its solution through the evaporation/condensation process. The individual processes are also applicable in many other equipment where individual evaporation and condensation processes are implemented. The flow passages are of varying cross section such that the flow velocity is adjusted with the local mass flow rate at any section. In other words, the increase in mass flow rate due to evaporation along the vapor flow length is matched with an increase in the flow cross-sectional area. The velocity changes are reduced in the varying cross-sectional area passages as compared to constant flow cross-sectional area. It is recognized that the flow velocity depends on both the evaporation rate in the evaporator in the downstream region and the rate of area increase. Similarly, the condenser will be related except the area needs to be reduced as the vapor condenses and the vapor mass flow rate decreases.

Heat exchangers, including compact heat exchangers in series, parallel, or any combination thereof are employed to operate the evaporation and condensation processes within the set limits of vapor velocity, from 0.1 m/s to 100 m/s, preferably from 1 m/s to 100 m/s, further preferably from 5 m/s to 40 m/s, and more preferably from 5 m/s to 25 m/s in the heat exchanger passages, by utilizing intermediate vapor extraction and intermediate feed water injection in the evaporator and, intermediate vapor injection and intermediate condensate removal from the condenser.

The sensors, controls, charging connections, monitoring, recirculation or any other features on any of the components or system discussed or shown in any of the figures may be applied to any of the configurations shown or discussed for implementing the disclosure herein. The heat exchangers can be utilized in multi-staging or cascading arrangement.

The evaporation and condensation processes occur in passages where the area increase in the case of evaporation and area decrease in the case of condensation corresponds to an included angle between the plate of 0 degree, representing a uniform cross-sectional area with no area change, and about 20 degrees. Another way to implement the area changes is in a stepped fashion. The gap height is changed in a stepped manner. Although there is a local discontinuity in the gap height, the vapor velocities are maintained within the desired range. Similarly, curved surfaces can also be used to achieve the area changes. The goal is to keep the velocity in a certain range. Care is also taken to avoid dead zones where the liquid could stagnate or vapor shear is not imparted on the liquid film. As the vapor flows in the evaporator in the confined passage, intermediate vapor removal along the vapor flow length can be accomplished and the gap height reduced. This helps in reducing the size of the unit as well as unnecessary passage of vapor in the confined passages contributing to pressure drop. The heat exchanger sections in each of the evaporators and condensers could be continuous over the length of the vapor flow path or could be intermittent separated by adiabatic plate sections.

Multiple evaporators can be used in a parallel fashion. Multiple condensers can be used in a parallel fashion. This can be implementing by changing the size the heat exchanger in different sections in the evaporator and condenser. The flow of vapor from the evaporator to the condenser may introduce a pressure drop. Larger space for this connection may increase the vacuum pump requirement to evacuate a larger volume. This space can be kept low by designing arrangement that reduces the pressure drop and volume requirements for the connecting space.

The vacuum operation lowers the saturation temperature of the liquid. The saturation temperature is matched with the available heating or cooling fluid temperatures in evaporators and condensers, respectively. It is further recognized that if the available temperature is above the saturation temperature corresponding to the atmospheric pressure, the system may be pressurized. For example, in case of water at atmospheric pressure, if the available heating fluid temperature is above 100° C., then the system may operate at higher pressure than the atmospheric pressure. By multi-staging, the system may be operated at different temperature levels between the highest available heating source temperature and the lowest condensation coolant temperature available. The multi-staging is commonly employed in desalination systems. These systems can be modified to include the benefits of varying cross-section for the vapor flow velocity in either or both the condenser and the evaporator. In one embodiment, the cross-sectional area variation is implemented in at least 50 percent of the flow length of the evaporator or condenser. The local baffles in desalination systems also generate local variation in the cross-sectional area. The flow area variation in one embodiment has at least one of the surfaces of the passages that is ether heated in an evaporator or cooled in a condenser. The effect of flow on the film flow in evaporator and condensate flow in condensers is affected.

Theoretical considerations supporting the disclosure are described here. In many places in this disclosure, water is used as the evaporated liquid. The ideas presented here are applicable to a system using another fluid being evaporated and condensed and water may be replaced with that fluid in the description.

In a system with only a water vapor environment, the effect of lowering pressure in the system reduces the saturation temperature of water in the evaporator. This allows for the use of lower temperature heat source, such as solar or waste heat, for evaporation. Another way to lower the evaporation temperature of water in the evaporator is by introducing air in the system. The partial pressure of water in the air is lower than the total pressure, and evaporation can be accomplished with a lower temperature heat source. Such systems are termed humidification-dehumidification systems. One drawback of the humidification-dehumidification system is that in the condenser, the non-condensable gases, air in the case of conventional humidification-dehumidification systems, accumulate as the water vapor condenses out from the mixture. Water vapor from the bulk vapor diffuses through this layer of non-condensable gases. This introduces a mass transfer resistance which causes a deterioration in heat transfer and an accompanying deterioration in water condensation rate. The system efficiency therefore suffers.

Replacing air with helium in the humidification-dehumidification system is beneficial as helium has a higher mass diffusivity as compared to air. It also has a higher thermal conductivity as compared to air. These factors result in an improvement in heat transfer rate and the system efficiency for the same inlet heating and cooling fluid temperatures for a given system. A disadvantage of using helium is that air may leak in, or air may be introduced during initial charging operation, or due to outgassing of the feed water, also referred to as saline water or solution, from which water evaporates. To restore the environment of helium, the entire system has to be, in some cases, scavenged with helium and evacuated before filling with helium again.

In the present disclosure, the fact that mixture of air and helium has both higher mass diffusivity and higher thermal conductivity as compared to air is utilized. The mass diffusivity of the mixture of air and hydrogen is given by the reciprocal molar concentration average mass diffusivities of the constituent air and hydrogen. Thus, a system starting with high concentration of helium can tolerate a leakage of air into the system until the helium concentration drops below the lower acceptable limit of concentration from mass diffusivity and thermal conductivity standpoints. Further, the system can be operated under vacuum to reduce the saturation temperature requirement in the evaporator. The total system pressure will be dictated by amount of air, helium and the temperatures of the evaporator and condenser surfaces. Condenser surface temperature determines the lowest pressure in the system, and the flow and pressure drop considerations determine the pressures at various locations within the system.

Using tapered channels presents another advantage in the case of humidification-dehumidification system using air, helium, any inert gas, or a mixture of gases including air and helium. The vapor velocity introduces a shear stress at the heat transfer surfaces and water film in case of the evaporator and improves the heat transfer coefficients. In the condenser, it removes or thins the condensed water film on the condenser surface and improves the heat transfer and condensation rates. Further, the vapor flow effectively removes or thins out the layer of non-condensable gases that are left behind on the condensing surface as water vapor diffuses through this layer and condenses on the condenser plates. This diffusion resistance can introduce large temperature drops across the non-condensable gas layer and is responsible for lowering the condensation heat transfer rates in other applications, such as in power plants, as well. The tapered channels maintain the vapor velocity within the desired range as the vapor evaporates in the evaporator and condenses out in the condenser. As should become obvious, the taper and the cross-sectional area increases along the flow direction in the evaporator and it decreases in the flow direction in the condenser.

The partial pressure of water vapor in a mixture with a non-condensable gas is given by the following equation. Humidity ratio W, defined as mass of water vapor to the mass of dry gas, in a mixture with a gas is given by:

$$W = \frac{{M}_{W}}{{M}_{G}} \frac{{P}_{W}}{P - {P}_{W}} \qquad ( 1 )$$

where M_{W} and M_{G} are molecular weights of water and the gas, P is the pressure, and P_{W} is the partial pressure of water vapor in the mixture. The difference P−P_{W} represents the partial pressure of the gas, which could be a mixture of gases such as air and helium.

It is seen that as the molecular weight of the gas decreases, the humidity ratio increases and more water vapor is held in the vapor-gas mixture. Molecular weight of air is 28.988 and that of helium is 4.003. Adding helium to air thus decreases the molecular weight of the resulting mixture gas. This makes the humidity ratio increase with the addition of helium gas.

The water vapor pressure on the condenser plate corresponds to the saturation pressure at the plate temperature. The driving force for water vapor to diffuse from the bulk to the plate surface is the difference in partial pressures of water vapor in the bulk and the saturation vapor pressure corresponding to the condenser plate temperature. In the presence of a non-condensable gas, the gas is left behind and develops a layer over the condensing surface through which water vapor has to diffuse. The accumulated gas has to diffuse back from this layer to the bulk gas-vapor mixture. The diffusion coefficient of water determines the gas determines the rate at which the gas can diffuse back. Higher the diffusion rate, lower will be the resistance to mass transfer for vapor to diffuse as well. The diffusion coefficient of the gas determines the rate of gas diffusion.

The diffusion coefficient of water vapor in air at 20° C. is about 0.242 cm²/s while it is estimated to be 0.85 cm²/s. Addition of air to helium will reduce the diffusivity of water vapor in the air-helium mixture as compared to that in pure helium, but it will still higher than that of air.

In an embodiment, a liquid separation system, includes:
an evaporator, including:
a channel having two open ends, the channel including an evaporation plate, optionally two sidewalls, and a cover enclosing the channel;
a feed liquid inlet at one end of the channel;
a feed liquid outlet at the other end of the channel;
optionally, a vapor flow inlet at one end of the channel; and
a vapor flow outlet at the other end of the channel, wherein a vapor flowrate is sufficient to impart vapor shear on a feed liquid film flowing on the evaporation plate surface; and

a condenser, including:
a channel having two open ends, the channel including a condensation plate, two sidewalls and a cover enclosing the channel;
a vapor flow inlet at one end of the channel; and
a liquid flow outlet at the other end of the channel, optionally wherein a vapor flowrate is sufficient to impart vapor shear on the condensed liquid on the condensation plate surface.

In an embodiment, the liquid separation system includes at least one of a variable cross-sectional area evaporator and variable cross-sectional area condenser.

In an embodiment, the liquid separation system includes a liquid separator to remove the condensed liquid from the system.

In an embodiment, the liquid separation system includes a secondary condenser to condense additional vapor from the vapor stream exiting from the condenser.

In an embodiment, the liquid separation system includes a vapor removal system such as a vacuum pump to remove non-condensable gases from the system.

In an embodiment, the liquid separation system includes operation of the system by removing at least some of the non-condensable gases from the system prior to its operation.

In an embodiment, the liquid separation system includes operation of the system by removing at least some of the non-condensable gases from the system during its operation.

In an embodiment, the liquid separation system includes multi-staging with multiple evaporators operated with cascading the heating fluid stream in multistage evaporators to improve the system performance.

In an embodiment, the liquid separation system includes multi-staging with multiple condensers operated with cascading coolant fluid stream in multistage condensers to improve the system performance.

In an embodiment, the liquid separation system includes the liquid stream used as at least one of the heating fluid stream or cooling fluid stream in the multistage operation.

In an embodiment, the liquid separation system further includes heat exchangers, including compact heat exchangers in series, parallel, or any combination thereof are employed to operate the evaporation and condensation processes within the set limits of vapor velocity, from 0.1 m/s to 100 m/s, more preferably, 1 m/s to 100 m/s, more preferably 5 m/s to 40 m/s, more preferably 5 m to 25 m/s in the heat exchanger passages, by utilizing intermediate vapor extraction and intermediate feed water injection in the evaporator and, intermediate vapor injection and intermediate condensate removal from the condenser.

In an embodiment, in the liquid separation system the evaporator, condenser or both are operated by reducing pressure.

In an embodiment, the liquid separation system includes wherein the evaporator, condenser or both have an additional gas present, wherein the gas may be air, helium, hydrogen or a similar gas with low solubility in water or the solution being used.

In an embodiment, the liquid separation system includes, wherein the evaporator, condenser or both have an additional gas mixture present, wherein the gas mixture may contain air, helium, hydrogen or a similar gas with low solubility in water or the solution being used.

In an embodiment, the liquid separation system includes, wherein the gas mixture may contain air and helium with helium mole fraction in the range 0.01 mole fraction to 99.9 mole fraction, wherein a preferred range is 1 mole fraction to 99 percent mole fraction of helium in air.

In an embodiment, a desalination system has evaporation occurring from a liquid film flowing over a base plate and a flow of vapor over the liquid film in a confined passage over the base plate formed by a cover plate;

the confined passage formed between the base plate and the cover plate with closed sides forming an inlet and outlet openings in the vapor flow direction;

the base plate heated with a heat source and the liquid film receiving heat from the base plate;

the cross-sectional area for the vapor flow in the confined passage increasing in the vapor flow direction, corresponding to an included angle of 0 to 20 degrees between the base plate and the cover plate facing it, a more preferred angle of 1 to 10 degrees, a further preferred angle of 3 to 10 degrees;

the feed liquid distributed over the base plate, including gravity assisted, capillary force assisted or spray assisted liquid distribution;

the distributor placed at the top of the base plate and liquid flow as a film over the base plate due to gravity;

the base plate has grooves and other surface microstructures to break the flow of liquid film flow and enhance the heat transfer from the base plate to the liquid film;

the base plate has surface microstructures, coatings, nanostructures, grooves, fins, dimples, ripples, and other surface features to enhance the evaporation rate;

the gap between the base plate and cover plate varies from 1 mm to 200 mm, with a more preferred gap size from 5 mm to 50 mm, more preferably 5 mm to 20 mm;

the cover plate similar to the base plate with a liquid distributor;

the cover plate similar to the base plate with a heat source and the liquid film receiving heat from the cover plate;

the cover plate similar to the base plate with features to improve liquid distribution and evaporation rate;

the vapor velocity in the confined passage to improve the evaporation rate from the liquid;

the vapor velocity in the confined passage to improve the heat transfer from the base plate and the liquid flowing over the base plate;

the vapor velocity in the confined passage to improve the heat transfer from the heat exchanger in the cover plate to the liquid flowing over the cover plate;

the excess feed liquid removed from the confined passage;

the evaporated vapor removed from the larger opening of the confined passage at the exit of the vapor flow; and

the vapor velocity in the increasing cross-sectional area direction maintained within 50 percent of the flow length-averaged mean vapor velocity in the confined region over at least 50 percent of the evaporation region length in the confined passage.

In an embodiment, a desalination system has condensation occurring from over a condensation plate and a flow of vapor in a confined passage over the condensation plate formed by a cover plate;

the confined passage formed between the condensation plate and the cover plate with closed sides forming an inlet and outlet openings in the vapor flow direction;

the condensation plate cooled with a cooling medium and heat being removed from the condensation plate;

the condensation plate is at an angle between 0 and 180 degrees with angles less than 90 degrees yielding condensation surface facing upward, with preferred angles of 5 degrees to 180 degrees.

The cross-sectional area for the vapor flow in the confined passage decreasing in the vapor flow direction, corresponding to an included angle of 0 to 20 degrees between the condensation plate and the cover plate facing it, a more preferred angle of 0.5 to 10 degrees, an another more preferred angle of 1 to 10 degrees, a further preferred angle of 3 to 10 degrees;

the condensate removed from the condensation plate, including but not limited to gravity-assisted, capillary force assisted, vapor-shear assisted condensate removal;

the condensation plate has grooves and other surface features including but not limited to wettability features, microstructures, and coatings, to break the flow of condensate flow and enhance the condensation heat transfer from the condensation plate;

the condensation plate has surface microstructures, coatings, nanostructures and surface features to enhance the condensation rate or the flow of condensate;

the gap between the condensation plate and the cover plate varies from 1 mm to 200 mm, with a more preferred gap size from 5 mm to 50 mm, more preferably 5 mm to 20 mm;

the cover plate has features similar to the condensation features, including heat exchanger, surface features, and all other features to act as a condensation plate;

the vapor velocity in the confined passage assisting in improving condensation heat transfer;

the vapor velocity in the confined passage assisting in improving condensate removal from the condensation plate;

the vapor velocity in the confined passage assisting in reducing the buildup of non-condensable gases over the condensing surfaces;

the condensate removed from the confined passage;

the vapor and non-condensable gases removed from the opening of the confined passage at the exit of the vapor flow;

the vapor velocity in the decreasing cross-sectional area direction maintained within 50 percent of the flow length-averaged mean vapor velocity in the confined region over at least 50 percent of the condensation region length in the confined passage;

the vapor exiting the condenser along with the non-condensable gases flow over a secondary condenser to condense the vapor;

a vacuum source or a vacuum pump to remove the non-condensable gases and the vapor from the secondary condenser;

removal of condensate from the condenser and after condenser using gravity, pump or any other means; and

heat exchangers, including compact heat exchangers in series, parallel, or any combination thereof are employed to operate the evaporation and condensation processes within the set limits of vapor velocity, from 0.1 m/s to 100 m/s, more preferably, 1 m/s to 100 m/s, more preferably 5 m/s to 40 m/s, more preferably 5 m to 25 m/s in the heat exchanger passages, by utilizing intermediate vapor extraction and intermediate feed water injection in the evaporator and, intermediate vapor injection and intermediate condensate removal from the condenser.

In an embodiment, a system separates a liquid from a solution using evaporation and condensation process;

the system being a desalination system to produce water from sea water or brackish water;

the system has an evaporator to evaporate liquid into vapor;

the vapor condensed in a condenser;

the system operated at a pressure below the atmospheric pressure for utilizing the lower temperature heat source;

the system is operated in the presence of a gas that has low solubility in the water or solution being used, wherein the gas may be pure gas such as air, helium, hydrogen, etc. or the gas may be a mixture of gases, with helium being one of the constituents;

the mole fraction of helium in the mixture may range from 0.01 to 99.9 mole fraction of the mixture of gases, wherein the other constituent may be air, nitrogen or any other pure gas or mixture of gases;
the heat exchangers in the evaporator and condenser employing multi-staging and cascading of the heating and cooling streams to improve the system efficiency as defined by the condensate output for a unit energy input to supply heat to the evaporation surfaces and operate vacuum pump, liquid pumps and cooling systems.

In an embodiment, an evaporator is disclosed wherein a non-condensable gas or a mixture of non-condensable gas and vapor flows into the evaporator and exits along with the vapor generated in the evaporator.

The disclosure will be further illustrated with reference to the following specific examples. It is understood that these examples are given by way of illustration and are not meant to limit the disclosure or the claims to follow.

### Example 1—Operation of the Desalination System with Helium and Air Mixture

The desalination system is operated in an environment of helium gas or a mixture of helium and air. The pressure is regulated by using a vacuum pump and the pressurized helium cylinders. In one embodiment, the following steps are followed.

1. The system is initially checked for leakages. The system is equipped with pressure gage to monitor the system pressure. It is then connected to a vacuum pump to remove air from the system and attain a desired pressure. The valve connecting the system to the vacuum pump is opened. In this example, the pressure is reduced to 0.1 kPa. The connecting valve is closed and the vacuum pump is disconnected.

2. The system is connected to a helium cylinder. The connecting valve is opened. The helium tank is set to the desired pressure using a pressure regulator. The helium tank valve is opened until the system reaches the desired pressure. In this example, the pressure is set at 90 kPa.

3. The valves are closed and the helium tank is disconnected.

4. The system operation is started as a batch type process or a continuous process by using appropriate pressure in the inlet and outlet streams.

5. Depending on the temperatures used in the evaporator and condenser, the system pressure will settle to a certain value. If desired, this pressure can be increased or decreased by adding more helium or evacuating the system using the vacuum pump using appropriate valves.

6. After the desired hours of operation, the system can be shut off. If some of the helium gas is leaked, then the pressure will fall. If air has entered the system, then the pressure will rise. If the molar concentration of helium in the system is within the desired limits as determined from the limits set on helium concentrations, the system will perform with a performance that is enhanced as compared to a system without helium gas in the system.

7. When the concentration of the helium falls below the set limit, helium gas may be added if the additional pressure is acceptable. If not, the system may be evacuated and filled with helium gas to the desired pressure.

8. Knowing the system volume and pressure at every stage of charging process, the concentration of helium in the system can be estimated. If the system performance deteriorates, then the helium concentration may be checked and additional helium may be charged, or the system evacuated to remove the higher concentration of air and helium charging may be done. A sensor showing the concentration of helium may be used for measuring the concentration of helium in the system.

9. Depending on the evaporating and condensing stream temperatures and flow rates, the desired pressures and concentration limits may be set. In this example, a heating stream temperature of 80° C. is used and a condensing stream temperature of 25° C. is used.

10. Depending on the desired flow rates of the saline water, heating fluid and cooling fluid streams, and desalination capacity, the desired system pressure limits and helium concentration limits may be estimated. System characterization may be done to obtain the information on how the system responds to the changes in temperatures, pressure and helium concentration in the system.

11. In another embodiment, the system may be operated with only helium gas and a small amount of air as obtained by the vacuum level during purging of the system with vacuum pump. If very low concentrations of air are desired, then the system can be evacuated once again after filling with helium to a desired level. If the system is operated at a lower than atmospheric pressure and air leaks in, the system may be tolerant to the presence of air if the helium level is within the acceptable limits set as determined by the operating system design parameters.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. An evaporator, comprising:
a flow channel having two open ends, the flow channel comprising a heat transfer plate, optionally two sidewalls, and a cover plate enclosing the flow channel;
a feed liquid inlet at one end of the flow channel;
a feed liquid outlet at the other end of the flow channel;
optionally, a vapor flow inlet at one end of the flow channel; and
a vapor flow outlet at the other end of the flow channel, wherein a gap at the feed liquid outlet between the surface of the heat transfer plate and the surface of the cover plate is in the range of from 1 mm to 200 mm and wherein an angle between the surface of the heat transfer plate and the surface of the cover plate is in the range of from 0.5 to 20 degrees.

2. The evaporator of claim 1, wherein the heat transfer plate has surface features of one or more of fins, grooves, ridges, dimples, microchannels, swirl generators, ripple generators, wave generators, porous surfaces, porous coatings, hydrophilic coatings, hydrophilic surface treatment, biphilic surfaces, nanostructures, capillary flow structures, enhanced evaporation surfaces, and liquid film flow disruptors.

3. The evaporator of claim 1, wherein at least one of the heat transfer plate and the cover plate has a stepped surface to provide the increase in cross-sectional flow area for the vapor.

4. The evaporator of claim 1, wherein the flow channel comprises a cross-sectional area increasing in the vapor flow direction.

5. The evaporator of claim 1, wherein the cover plate is a heat transfer plate.

6. A condenser, comprising:
a flow channel having two open ends, the flow channel comprising a heat transfer plate, optionally two sidewalls, and a cover plate enclosing the flow channel;
a vapor inlet at one end of the flow channel; and
a condensed liquid outlet at the other end of the flow channel, wherein a gap at the condensed liquid outlet between the surface of the heat transfer plate and the surface of the cover plate is in the range of from 1 mm to 200 mm and wherein an angle between the surface of the heat transfer plate and the surface of the cover plate is in the range of from 0.5 to 20 degrees.

7. The condenser of claim 6, wherein the heat transfer plate has surface features of one or more of fins, grooves, ridges, dimples, microchannels, swirl generators, ripple generators, wave generators, porous surfaces, porous coatings, hydrophilic coatings, hydrophilic surface treatment, biphilic surfaces, nanostructures, capillary flow structures, enhanced evaporation surfaces, liquid film flow disruptors, microstructures to trip the condensate flow, microstructures to reduce the film thickness, and microstructures to remove the condensate film.

8. The condenser of claim 6, wherein at least one of the heat transfer plate and the cover plate has a stepped surface to provide the decrease in cross-sectional flow area for the vapor in the vapor flow direction.

9. The condenser of claim 6, wherein the flow channel comprises a cross-sectional area decreasing in the vapor flow direction.

10. The condenser of claim 6, wherein the cover plate is a heat transfer plate.

11. A combined evaporator and condenser unit, comprising:
an evaporator flow channel having two open ends, optionally two sidewalls, and an evaporator cover plate enclosing the evaporator flow channel;
an evaporator flow channel feed liquid inlet at a first end of the unit;
an evaporator flow channel feed liquid outlet at a second end of the unit;
optionally, an evaporator flow channel vapor flow inlet at the second end of the unit;
an evaporator vapor flow outlet at the first end of the flow channel;
a condenser flow channel having two open ends, optionally two sidewalls, and a condenser cover plate enclosing the condenser flow channel;
a condenser flow channel vapor inlet at the first end of the unit;
a condenser liquid outlet at the second end of the unit; and
a common heat transfer plate disposed between the evaporator cover plate and the condenser cover plate, wherein an evaporator gap at the second end of the unit between the common heat transfer plate and the evaporator cover plate and a condenser gap at the second end of the unit between the common heat transfer plate and the cover plate are each independently in the range of from 1 mm to 200 mm and wherein an angle between the surface of the common heat transfer plate and the surface of the evaporator cover plate and an angle between the surface of the common heat transfer plate and the surface of the evaporator cover plate are each independently in the range of from 0.5 to 20 degrees.
